(19) United States
(12) Patent Application Publication
(10) Pub. No.: US 2010/0126344 A1
(43) Pub. Date: May 27, 2010

(54) MIXTURE COMPRISING A METAL ORGANIC FRAMEWORK AND ALSO A LATENT HEAT STORE

(75) Inventors: Hildegard Stein, Mannheim (DE); Joerg Pastre, Bensheim (DE); Markus Schubert, Ludwigshafen (DE); Christoph Kiener, Weisenheim am Sand (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/594,347

(22) PCT Filed: Apr. 1, 2008
(86) PCT No.: PCT/EP08/53859

§ 371 Date: Oct. 2, 2009

(30) Foreign Application Priority Data
Apr. 5, 2007 (EP) 07105775.6

(51) Int. Cl. B01D 53/047; C09K 3/00

(52) U.S. Cl. 95/96; 252/70; 95/95

(57) ABSTRACT

The present invention relates to mixtures comprising, in each case based on the total weight of the mixture,
a) from 2 to 60% by weight of a latent heat storage component A and
b) from 40 to 98% by weight of a framework component B,
   wherein the component A comprises at least one microencapsulated latent heat storage material and the component B comprises at least one porous metal organic framework comprising at least one at least bidentate organic compound coordinated to at least one metal ion.

The present invention further relates to the use of such mixtures, in particular in processes for separating substances from a mixture of substances.

The present invention relates to mixtures comprising a latent heat storage component A and a framework component B, the use of such mixtures and also a process for separating a substance from a mixture of substances by means of such mixtures.

Numerous adsorbents have been described in the prior art for the adsorptive uptake of substances, in particular gases. Frequently used adsorbents are activated carbon, silica gel, zeolites and recently porous metal organic frameworks.

The adsorption of, for example, gases typically occurs exothermically, so that the adsorbent is heated during the adsorption by uptake of the energy liberated. However, this heat uptake can be disadvantageous for the intended adsorption purpose. Thus, for example, in the case of a separation, separation efficiency can be reduced.

An analogous situation applies in desorption, where the desorption process can be adversely affected by the reduction in temperature.

To avoid this, the temperature can be regulated externally, for example by means of heat exchangers. In addition, there is the possibility of regulating the heat evolved by means of further material. This material is typically a latent heat store which undergoes a phase change at a predetermined temperature, so that the energy liberated by adsorption is used for this phase change, which produces the effect that the temperature of the adsorbent material does not increase or increases to a lesser extent.

WO-A 2004/050789 proposes a composite material which combines both adsorptive material and a latent heat store in the composite material. Similar systems are proposed in JP-A 2001/145832 and JP-A 2003/311118.

However, the production of such composite materials is complicated, so that there is a need for systems which are simpler to produce and at least partly more efficient.

It is therefore an object of the present invention to provide systems of this type, in particular for use in the separation of one substance from a mixture of substances.

This object is achieved by a mixture comprising, in each case based on the total weight of the mixture,
a) from 2 to 60% by weight of a latent heat storage component A and
b) from 40 to 98% by weight of a framework component B,
   wherein the component A comprises at least one microencapsulated latent heat storage material and the component B comprises at least one porous metal organic framework comprising at least one at least bidentate organic compound coordinated to at least one metal ion.

It has been found that simple mixtures of the components A and B in the abovementioned proportions by weight represents simple and efficient systems which can be used, in particular, in the separation of substances.

The mixture of the invention comprises a latent heat storage component A and a framework component B. The mixture can additionally comprise further components.

Here, the proportion of component A is from 2 to 60% by weight based on the total weight of the mixture. The proportion of component A is preferably from 10 to 50% by weight based on the total weight of the mixture. In particular, preference is given to a proportion of from 15 to 45% by weight of the component A based on the total weight of the mixture.

Furthermore, the proportion of the framework component B is from 40 to 98% by weight based on the total weight of the mixture. This proportion is preferably from 50 to 90% by weight and particularly preferably from 55 to 85% by weight based on the total weight of the mixture.

The latent heat component A comprises at least one microencapsulated latent heat storage material. The material and the microencapsulation together form the latent heat store.

In addition, it is possible to use further different latent heat stores. This is advantageous particularly when different temperatures are to be addressed by the phase change of the latent heat stores.

The microencapsulated latent heat storage materials of the latent heat storage component A are preferably particles having a capsule core comprising predominantly, viz. more than 95% by weight of, latent heat storage materials and a polymer as capsule wall.

The capsule core is solid or liquid as a function of the temperature. The mean particle size of the capsules (number-average by means of light scattering) is typically from 0.5 to 100 μm, preferably from 1 to 80 μm, in particular from 1 to 50 μm. The weight ratio of capsule core to capsule wall is generally from 50:50 to 95:5. Preference is given to a core/wall ratio of from 70:30 to 93:7.

Latent heat storage materials are by definition substances which have a phase transition in the temperature range in which heat transfer is to be effected. For example, the latent heat storage materials have a solid/liquid phase transition in the temperature range from −20° C. to 120° C. Preference is accordingly given to the at least one encapsulated latent heat storage material having a melting point in the range from −20° C. to 120° C. Greater preference is given to a range from 0° C. to 80° C. and in particular a range from 20° C. to 60° C.

For the purposes of the present invention, the term “melting point” is also used in the interest of simplicity when the latent heat storage material has a melting range. In this case, the lower limit of the melting range is then to be considered to be the melting point for the purposes of the present invention. If a number of melting points and/or melting ranges occur, it suffices for only one of these to occur in the prescribed temperature range. However, preference is given to more than one, in particular all, occurring in the prescribed temperature range.

In general, the latent heat storage material is an organic, preferably lipophilic, substance.

Examples of suitable substances are:
aliphatic hydrocarbon compounds such as saturated or unsaturated C₁₀-C₄₀-hydrocarbons which are branched or preferably linear, e.g. n-tetradecane, n-pentadecane, n-hexadecane, n-heptadecane, n-octadecane, n-nonadecane, n-eicosane, n-heneicosane, n-docosane, n-tricosane, n-tetracosane, n-pentacosane, n-hexacosane, n-heptacosane, n-octacosane, and also cyclic hydrocarbons, e.g. cyclohexane, cyclooctane, cyclodecane;
aromatic hydrocarbon compounds such as benzene, naphthalene, biphenyl, o- or n-terphenyl, C₁-C₄₀-alkyl-substituted aromatic hydrocarbons such as dodecylbenzene, tetradecylbenzene, hexadecylbenzene, hexylnaphthalene or decylnaphthalene;
saturated or unsaturated C₆-C₃₀-fatty acids such as lauric, stearic, oleic or behenic acid, preferably eutectic mixtures of decanoic acid with, for example, myristic, palmitic or lauric acid;
fatty alcohols such as lauryl, stearyl, oleyl, myristyl, cetyl alcohol, mixtures such as coconut oil alcohol and the oxo alcohols obtained by hydroformylation of α-olefins and further reactions;
C₆-C₃₀-fatty amines such as decylamine, dodecylamine, tetradecylamine or hexadecylamine;
esters such as C₁-C₁₀-alkyl esters of fatty acids, e.g. propyl palmitate, methyl stearate or methyl palmitate, and also, preferably, their eutectic mixtures or methyl cinnamate;
natural and synthetic waxes such as montanic acid waxes, montanic ester waxes, carnauba wax, polyethylene wax, oxidized waxes, polyvinyl ether wax, ethylene-vinyl acetate wax or hard waxes obtained by Fischer-Tropsch processes;
halogenated hydrocarbons such as chloroparaffin, bromooctadecane, bromopentadecane, bromononadecane, bromoeicosane, bromodocosane.

Mixtures of these substances are also suitable as long as they do not result in a lowering of the melting point to outside the desired range or the heat of fusion of the mixture becomes too low for effective use.

It is advantageous to use, for example, pure n-alkanes, n-alkanes having a purity of greater than 80% or alkane mixtures as are obtained as industrial distillate and are commercially available as such.

It can also be advantageous to add compounds which are soluble in the substances forming the capsule core to the substances in order to prevent the delay in crystallization which sometimes occurs in the case of nonpolar substances. It is advantageous to use, as described in U.S. Pat. No. 5,456,852, compounds having a melting point which is 20-120 K higher than that of the actual core substance. Suitable compounds are the fatty acids, fatty alcohols, fatty amides and aliphatic hydrocarbon compounds mentioned above as lipophilic substances. They are added in amounts of from 0.1 to 10% by weight based on the capsule core.

The latent heat storage materials are selected according to the temperature range in which the heat stores are to be used.

Preferred latent heat storage materials are aliphatic hydrocarbons, particularly preferably those listed above by way of example. Particular preference is given to aliphatic hydrocarbons having from 14 to 20 carbon atoms and mixtures thereof.

In the preferred latent heat storage microcapsules, the polymers forming the capsule wall preferably comprise from 30 to 100% by weight, more preferably from 30 to 95% by weight, of one or more C₁-C₂₄-alkyl esters of acrylic and/or methacrylic acid as monomer I. In addition, the polymers can comprise, in copolymerized form, up to 80% by weight, preferably from 5 to 60% by weight, in particular from 10 to 50% by weight, of a bifunctional or polyfunctional monomer as monomer II which is insoluble or sparingly soluble in water. Furthermore, the polymers can comprise up to 90% by weight, preferably up to 50% by weight, in particular up to 30% by weight, of other monomers III in copolymerized form.

Suitable monomers I are C₁-C₂₄-alkyl esters of acrylic and/or methacrylic acid. Particularly preferred monomers I are methyl, ethyl, n-propyl and n-butyl acrylates and/or the corresponding methacrylates. Preference is given to isopropyl, isobutyl, sec-butyl and tert-butyl acrylates and the corresponding methacrylates. Mention may also be made of methacrylic acid. The methacrylates are generally preferred.

Suitable monomers II are bifunctional or polyfunctional monomers which are insoluble or sparingly soluble in water but have a good to limited solubility in the lipophilic substance. For the purposes of the present invention, sparingly soluble is a solubility of less than 60 g/l at 20° C. Bifunctional or polyfunctional monomers are compounds which have at least 2 nonconjugated ethylenic double bonds. Divinyl and polyvinyl monomers which effect crosslinking of the capsule wall during the polymerization are particularly useful.

Preferred bifunctional monomers are the diesters of diols with acrylic acid or methacrylic acid, also the diallyl and divinyl ethers of these diols.

Preferred divinyl monomers are ethanediol diacrylate, divinylbenzene, ethylene glycol dimethacrylate, 1,3-butylene glycol dimethacrylate, methallylmethacrylamide and allyl methacrylate. Particular preference is given to the diacrylates of propanediol, butanediol, pentanediol and hexanediol and also the corresponding methacrylates.

Preferred polyvinyl monomers are trimethylolpropane triacrylate and trimethacrylate, pentaerythritol triallyl ether and pentaerythritol tetraacrylate.

The monomers III are other monomers, preferably monomers IIIa such as vinyl acetate, vinyl propionate and vinylpyridine.

Particular preference is given to the water-soluble monomers IIIb, e.g. acrylonitrile, methacrylonitrile, methacrylamide, acrylic acid, itaconic acid, maleic acid, maleic anhydride, N-vinylpyrrolidone, 2-hydroxyethyl acrylate and methacrylate and acrylamido-2-methylpropanesulfonic acid. In addition, particular mention may be made of N-methylolacrylamide, N-methylolmethacrylamide, dimethylaminoethyl methacrylate and diethylaminoethyl methacrylate.

In a further preferred embodiment, the wall-forming polymers comprise from 30 to 90% by weight of methacrylic acid, from 10 to 70% by weight of an alkyl ester of (meth)acrylic acid, preferably methyl methacrylate, tert-butyl methacrylate, phenyl methacrylate and cyclohexyl methacrylate, and from 0 to 40% by weight of further ethylenically unsaturated monomers. These further ethylenically unsaturated monomers can be the monomers I, II or III which have not previously been mentioned for this embodiment. Since they generally do not have a significant influence on the microcapsules formed in this embodiment, their proportion is preferably <20% by weight, in particular <10% by weight. Such microcapsules and their production are described in EP-A-1 251 954, which is expressly incorporated by reference.

The microencapsulation (capsule wall) particularly preferably comprises a homopolymer or copolymer based on methyl methacrylate (MMA), for example polymethyl methacrylate (PMMA). The abovementioned microcapsules can be produced by an in-situ polymerization.

The preferred microcapsules and their production are known from EP-A 457 154, DE-A 10 139 171, DE-A 102 30 581 and EP-A 1 321 182, which are expressly incorporated by reference. Thus, the microcapsules are produced by producing a stable oil-in-water emulsion from the monomers, a free-radical initiator, a protective colloid and the lipophilic substance to be encapsulated, in which emulsion these components are present as disperse phase. The polymerization of the monomers is subsequently started by heating and is controlled by means of a further increase in temperature, with the resulting polymers forming the capsule wall which encloses the lipophilic substance.

In general, the polymerization is carried out at from 20 to 100° C., preferably from 40 to 80° C. Naturally, the dispersion and polymerization temperature should be above the melting point of the lipophilic substances.

After the final temperature has been reached, the polymerization is advantageously continued for a further period of up to 2 hours in order to reduce residual monomer contents. After the actual polymerization reaction at a conversion of from 90 to 99% by weight, it is generally advantageous for the aqueous microcapsule dispersions to be essentially freed of odor imparters such as residual monomers and other volatile organic constituents. This can be achieved by physical means in a manner known per se by means of distillation (in particular steam distillation) or by stripping with an inert gas. Furthermore, it can be achieved chemically as described in WO 9924525, advantageously by redox-initiated polymerization as described in DE-A 4 435 423, DE-A 4419518 and DE-A 4435422.

It is in this way possible to produce microcapsules having a mean particle size in the range from 0.5 to 100 μm, with the particle size being able to be set in a manner known per se via the shear force, the stirring rate, the protective colloid and its concentration.

The microcapsules are generally produced in the presence of at least one organic protective colloid which can be either anionic or uncharged. It is also possible to use anionic and nonionic protective colloids together. Preference is given to using inorganic protective colloids, if appropriate in admixture with organic protective colloids or nonionic protective colloids.

Organic protective colloids are water-soluble polymers, since these reduce the surface tension of water from 73 mN/m to a maximum of 45-70 mN/m and thus ensure the formation of closed capsule walls and also form microcapsules having preferred particle sizes of from 0.5 to 30 μm, preferably from 0.5 to 12 μm.

Organic uncharged protective colloids are cellulose derivatives such as hydroxyethylcellulose, methylhydroxyethylcellulose, methylcellulose and carboxymethylcellulose, polyvinylpyrrolidone, copolymers of vinylpyrrolidone, gelatin, gum arabic, xanthan, sodium alginate, casein, polyethylene glycols, preferably polyvinyl alcohol and partially hydrolyzed polyvinyl acetates and also methylhydroxypropylcellulose. Particularly preferred organic uncharged protective colloids are protective colloids bearing OH groups, e.g. polyvinyl alcohol and partially hydrolyzed polyvinyl acetates and also methylhydroxypropylcellulose.

Suitable organic anionic protective colloids are polymethacrylic acid, the copolymers of sulfoethyl acrylate and methacrylate, sulfopropyl acrylate and methacrylate, of N-(sulfoethyl)maleimide, of 2-acrylamido-2-alkylsulfonic acids, styrenesulfonic acid and of vinylsulfonic acid.

Preferred organic anionic protective colloids are naphthalenesulfonic acid and naphthalenesulfonic acid-formaldehyde condensates and especially polyacrylic acids and phenolsulfonic acid-formaldehyde condensates.

As inorganic protective colloids, mention may be made of Pickering systems which make stabilization possible by means of very fine solid particles and are insoluble but dispersible in water or insoluble and not dispersible in water but wettable by the lipophilic substance.

The mode of action and their use is described in EP-A 1 029 018 and EP-A 1 321 182, whose contents are expressly incorporated by reference.

A Pickering system can comprise the solid particle alone or together with auxiliaries which improve the dispersibility of the particles in water or improve the wettability of the particles by the lipophilic phase.

The inorganic solid particles can be metal salts such as salts, oxides and hydroxides of calcium, magnesium, iron, zinc, nickel, titanium, aluminum, silicon, barium and manganese. Mention may be made of magnesium hydroxide, magnesium carbonate, magnesium oxide, calcium oxalate, calcium carbonate, barium carbonate, barium sulfate, titanium dioxide, aluminum oxide, aluminum hydroxide and zinc sulfide. Silicates, bentonite, hydroxyapatite and hydrotalcites may likewise be mentioned. Particular preference is given to finely divided silicas, magnesium pyrophosphate and tricalcium phosphate.

The Pickering systems can either be added initially to the water phase or can be added to the stirred emulsion of oil-in-water. Some fine, solid particles are prepared by precipitation, as described in EP-A 1 029 018 and EP-A 1 321 182.

The finely divided silicas can be dispersed as fine, solid particles in water. However, it is also possible to use colloidal dispersions of silica in water. The colloidal dispersions are alkaline, aqueous mixtures of silica. In the alkaline pH range, the particles are swollen and stable in water. For use of these dispersions as Pickering system, it is advantageous for the pH of the oil-in-water emulsion to be set to a pH of from 2 to 7 by means of an acid.

In general, the uncharged protective colloids are used in amounts of from 0.1 to 15% by weight, preferably from 0.5 to 10% by weight, based on the water phase. Inorganic protective colloids are generally used in amounts of from 0.5 to 15% by weight, based on the water phase. Organic anionic and nonionic protective colloids are generally used in amounts of from 0.1 to 10% by weight, based on the water phase of the emulsion.

In one embodiment, inorganic protective colloids and mixtures with organic protective colloids are preferred.

In a further embodiment, organic uncharged protective colloids are preferred.

The dispersion conditions for producing the stable oil-in-water emulsion are preferably selected in a manner known per se so that the oil droplets have the size of the desired capsules. Microcapsules can also be obtained in this way.

The microcapsule dispersions obtained by means of the polymerization give a free-flowing capsule powder on spray drying. Spray drying of the microcapsule dispersion can be carried out in a customary way. In general, the inlet temperature of the hot air stream is in the range from 100 to 200° C., preferably from 120 to 160° C., and the outlet temperature of the hot air stream is in the range from 30 to 90° C., preferably from 60 to 80° C. The atomization of the aqueous polymer dispersion in the hot air stream can, for example, be effected by means of single-fluid or multifluid nozzles or a rotating disk. The precipitation of the polymer powder is normally carried out using cyclones or filters. The atomized aqueous polymer dispersion and the hot air stream are preferably conveyed in parallel.

If appropriate, spraying aids are added for spray drying in order to aid spray drying or to set particular powder properties, e.g. a low dust content, ability to flow or improve redispersibility. A person skilled in the art will be familiar with many spraying aids. Examples may be found in DE-A 19629525, DE-A 19629526, DE-A 2214410, DE-A 2445813, EP-A 407889 or EP-A 784449. Advantageous spraying aids are, for example, water-soluble polymers such as polyvinyl alcohol or partially hydrolyzed polyvinyl acetates, cellulose derivatives such as hydroxyethylcellulose, carboxymethylcellulose, methylcellulose, methylhydroxyethylcellulose and methylhydroxypropylcellulose, polyvinylpyrrolidone, copolymers of vinylpyrrolidone, gelatin, preferably polyvinyl alcohol and partially hydrolyzed polyvinyl acetates and also methylhydroxypropylcellulose.

The latent heat storage component A can comprise latent heat stores as powder or as shaped bodies, for example as granules. Here, all shapes known in the prior art, for example spherical, disk-shaped, water-shaped, ring-shaped or star-shaped bodies, are conceivable in principle. Preference is given to star-shaped bodies.

The dimensions of the shaped bodies for the component A are preferably in the range from 200 μm to 5 cm, more preferably in the range from 500 μm to 2 cm and in particular in the range from 1 mm to 1 cm. Accordingly, an appropriate shaped body has at least one dimension which is in the range from 0.2 mm to 5 cm. A similar situation applies to the preferred ranges.

These shaped particles can have an amorphous, spherical through to rod-like shape, depending on the respective method of production. In the case of spherical bodies, the mean diameter is preferably from 200 μm to 2 cm, more preferably from 500 μm to 1 cm. Rod-shaped bodies have a longest dimension of not more than 5 cm, in general in the range from 1 mm to 2 cm. The shortest dimension is usually at least 200 μm, in general from 500 μm to 10 mm, preferably from 500 μm to 5 mm. In the case of rod-shaped particles, the ratio of length to diameter is usually not more than 10:1, preferably not more than 5:1.

In the preferred microcapsule preparations, 90% by weight of the particles are >500 μm, preferably >700 μm, in particular >1 mm, determined by sieving techniques.

In one embodiment, the particles are unsymmetrical aggregates of powder particles which only approximately have the shape of a sphere, a rod or a cylinder and whose surface is frequently uneven and jagged. Such particles are often also referred to as granules or agglomerates. Another form of agglomerates is compacts, known as pellets or tablets, as are known from the production of drugs.

The particles according to the invention can, as indicated above, assume any geometric shapes. Basic geometric bodies can be, for example, spheres, cylinders, cubes, cuboids, prisms, pyramids, cones, truncated cones and truncated pyramids. Star extrudates, cross extrudates, ribbed extrudates and trilobes are also suitable. The geometric bodies can be either hollow or solid. Hollow spaces, e.g. introduced tubes, increase the surface area of the geometric body while simultaneously reducing its volume. Star-shaped bodies are preferred.

In one embodiment, preference is given to particles whose ratio of surface area to volume obeys the following relationship:

$$\frac{\sqrt[2]{Surface area}}{\sqrt[3]{Volume}} \geq 2.5 ,$$

preferably ≧2.6, particularly preferably ≧2.8 and in particular ≧3.0.

For the present purposes, the terms surface area and volume refer to surface areas and volumes which can be perceived by eye when looking at the geometric body, i.e. internal volumes and surface areas originating from fine pores and/or cracks in the material of the geometric body are not included.

The pore area of the particles according to the invention measured by mercury porosimetry in accordance with DIN 66133 is preferably 2-100 m²/g.

The coarsely particulate shaped bodies or preparations according to the invention comprise, in one embodiment, at least 90% by weight of microcapsules and polymeric binder.

In another embodiment, the preparations according to the invention comprise at least 80% by weight of microcapsules and polymeric binder.

In this embodiment, the preparation comprises 2-20% by weight of graphite based on the total weight of the coarsely particulate preparation. Particular preference is given to graphite-comprising particles in which the ratio of surface area obeys the following relationship:

$$\frac{\sqrt[2]{Surface area}}{\sqrt[3]{Volume}} \geq 2.5 .$$

The binder content, calculated as solid, is preferably 1-40% by weight, more preferably 1-30% by weight, in particular 1-20% by weight and very particularly preferably 2-15% by weight, based on the total weight of the coarsely particulate preparation.

Preferred preparations comprise, based on their total weight, 55-94% by weight of latent heat storage material, 1-40% by weight of polymeric binder calculated as solid, microcapsule wall material and 0-10% by weight of other additives.

Particular preference is given to granules comprising 85-99% by weight of microencapsulated latent heat stores, 1-15% by weight of polymeric binder calculated as solid and 0-5% by weight of other additives.

Since the coarsely particulate microcapsule preparations are usually produced by processing with water or aqueous substances, the preparations can still comprise residues of water. The amount of residual moisture is usually from 0 to about 2% by weight, based on the total weight.

Polymeric binders are generally known. They are fluid systems which comprise, as disperse phase in an aqueous dispersion medium, dispersed balls of tangled polymer chains, known as the polymer matrix or polymer particles. The weight average diameter of the polymer particles is frequently in the range from 10 to 1000 nm, often from 50 to 500 nm or from 100 to 400 nm. Apart from the polymer, the polymeric binder comprises the auxiliaries described below.

According to the invention, it is in principle possible to use all finely divided polymers which are able to form a polymer film at the processing temperature, i.e. are film-forming at these temperatures, as polymeric binders. According to a preferred variant, the polymers are not water-soluble. This makes it possible for the coarsely particulate preparations according to the invention to be used in moist or aqueous systems.

According to the invention, it is possible to use polymers whose glass transition temperature is from −60 to +150° C., often from −20 to +130° C. and frequently from 0 to +120° C. The glass transition temperature (T_{g}) here is the limit approached by the glass transition temperature with increasing molecular weight, as described by G. Kanig (Kolloid-Zeitschrift & Zeitschrift für Polymere, Vol. 190, page 1, equation 1). The glass transition temperature is determined by the DSC method (differential scanning calorimetry, 20 K/min, midpoint measurement, DIN 53 765).

Very particular preference is given to polymers having a glass transition temperature in the range from 40 to 120° C. These are generally processed at temperatures in the range from 20 to 120° C. Crossly particulate compositions obtained in this way display a particularly good mechanical stability and have good abrasion values.

The glass transition temperature of polymers made up of ethylenically unsaturated monomers can be controlled in a known manner via the monomer composition (T. G. Fox, Bull. Am. Phys. Soc. (Ser. II) 1, 123 [1956] and Ullmanns Enzyklopedia of Industrial Chemistry 5th Edition, Vol. A21, Weinheim (1989) p. 169).

Preferred polymers are made up of ethylenically unsaturated monomers M which generally comprise at least 80% by weight, in particular at least 90% by weight, of ethylenically unsaturated monomers A having a solubility in water of <10 g/l (25° C. and 1 bar), with up to 30% by weight, e.g. from 5 to 25% by weight, of the monomers A being able to be replaced by acrylonitrile and/or methacrylonitrile. In addition, the polymers further comprise from 0.5 to 20% by weight of monomers B which are different from the monomers A. Here and in the following, all amounts of monomers in % by weight are based on 100% by weight of monomers M.

Monomers A are generally singly ethylenically unsaturated or are conjugated diolefins. Examples of monomers A are:
esters of an α,β-ethylenically unsaturated C₃-C₆-monocarboxylic acid or C₄-C₈-dicarboxylic acid with a C₁-C₁₀-alkanol; preferably esters of acrylic acid or methacrylic acid, e.g. methyl(meth)acrylate, ethyl(meth)acrylate, n-butyl (meth)acrylate, t-butyl(meth)acrylate, 2-ethylhexyl(meth)acrylate, etc;
vinylaromatic compounds such as styrene, 4-chlorostyrene, 2-methylstyrene, etc;
Vinyl esters of aliphatic carboxylic acids having preferably from 1 to 10 carbon atoms, e.g. vinyl acetate, vinyl propionate, vinyl laurate, vinyl stearate, the vinyl ester of Versatic acid, etc;
olefins such as ethylene or propylene;
conjugated diolefins such as butadiene or isoprene;
vinyl chloride or vinylidene chloride.

Preferred film-forming polymers are selected from among the polymer classes I to IV below:
I) copolymers of styrene with alkyl acrylates, i.e. copolymers comprising, as monomer A, styrene and at least one C₁-C₁₀-alkyl ester of acrylic acid and, if appropriate, one or more C₁-C₁₀-alkyl esters of methacrylic acid in polymerized form;
II) copolymers of styrene with butadiene, i.e. copolymers comprising, as monomer A, styrene and butadiene and, if appropriate, (meth)acrylic esters of C₁-C₈-alkanols, acrylonitrile and/or methacrylonitrile in polymerized form;
III) homopolymers and copolymers of alkyl(meth)acrylates (pure acrylates), i.e. homopolymers and copolymers comprising, as monomer A, at least one C₁-C₁₀-alkyl ester of acrylic acid and/or a C₁-C₁₀-alkyl ester of methacrylic acid in polymerized form, in particular copolymers comprising, as monomers A, methyl methacrylate, at least one C₁-C₁₀-alkyl ester of acrylic acid and, if appropriate, a C₂-C₁₀-alkyl ester of methacrylic acid in polymerized form;
IV) homopolymers of vinyl esters of aliphatic carboxylic acids and copolymers of vinyl esters of aliphatic carboxylic acids with olefins and/or alkyl(meth)acrylates, i.e. homopolymers and copolymers comprising, as monomer A, at least one vinyl ester of an aliphatic carboxylic acid having from 2 to 10 carbon atoms and, if appropriate, one or more C₂-C₆-olefins and/or, if appropriate, one or more C₁-C₁₀-alkyl esters of acrylic acid and/or methacrylic acid in polymerized form;
V) copolymers of styrene with acrylonitrile.

Typical C₁-C₁₀-alkyl esters of acrylic acid in the copolymers of classes I to IV are ethyl acrylate, n-butyl acrylate, tert-butyl acrylate, n-hexyl acrylate and 2-ethylhexyl acrylate.

Typical copolymers of class I comprise, as monomers A, from 20 to 80% by weight and in particular from 30 to 70% by weight of styrene and from 20 to 80% by weight, in particular from 30 to 70% by weight, of at least one C₁-C₁₀-alkyl ester of acrylic acid, e.g. n-butyl acrylate, ethyl acrylate or 2-ethylhexyl acrylate, in each case based on the total amount of monomers A.

Typical copolymers of class II comprise, as monomers A, in each case based on the total amount of monomers A, from 30 to 85% by weight, preferably from 40 to 80% by weight and particularly preferably from 50 to 75% by weight, of styrene and from 15 to 70% by weight, preferably from 20 to 60% by weight and particularly preferably from 25 to 50% by weight of butadiene, with from 5 to 20% by weight of the above-mentioned monomers A being able to be replaced by (meth)acrylic esters of C₁-C₈-alkanols and/or by acrylonitrile or methacrylonitrile.

Typical copolymers of class III comprise, as monomers A, in each case based on the total amount of monomers A, from 20 to 80% by weight, preferably from 30 to 70% by weight, of methyl methacrylate and at least one further monomer, preferably one or two further monomers, selected from among acrylic esters of C₁-C₁₀-alkanols, in particular n-butyl acrylate, 2-ethylhexyl acrylate and ethyl acrylate, and, if appropriate, a methacrylic ester of a C₂-C₁₀-alkanol in a total amount of from 20 to 80% by weight and preferably from 30 to 70% by weight in polymerized form.

Typical homopolymers and copolymers of class IV comprise, as monomers A, in each case based on the total amount of monomers A, from 30 to 100% by weight, preferably from 40 to 100% by weight and particularly preferably from 50 to 100% by weight, of a vinyl ester of an aliphatic carboxylic acid, in particular vinyl acetate, and from 0 to 70% by weight, preferably from 0 to 60% by weight and particularly preferably from 0 to 50% by weight, of a C₂-C₆-olefin, in particular ethylene, and, if appropriate, one or two further monomers selected from among (meth)acrylic esters of C₁-C₁₀-alkanols in an amount of from 1 to 15% by weight in polymerized form.

Among the abovementioned polymers, the polymers of classes IV and V are particularly useful.

Preference is given to homopolymers of vinyl esters of aliphatic carboxylic acids, in particular vinyl acetate. A particular embodiment encompasses those which are stabilized by protective colloids such as polyvinylpyrrolidone and anionic emulsifiers. An embodiment of this type is described in WO 02/26845, which is expressly incorporated by reference.

Possible monomers B are in principle all monomers which are different from the abovementioned monomers and can be copolymerized with the monomers A. Such monomers are known to those skilled in the art and generally serve to modify the properties of the polymer.

Preferred monomers B are selected from among monoethylenically unsaturated monocarboxylic and dicarboxylic acids having from 3 to 8 carbon atoms, in particular acrylic acid, methacrylic acid, itaconic acid, their amides such as acrylamide and methacrylamide, their N-alkylolamides such as N-methylolacrylamide and N-methylolmethacrylamide, their hydroxy-C₁-C₄-alkyl esters such as 2-hydroxyethyl acrylate, 2- and 3-hydroxypropyl acrylate, 4-hydroxybutyl acrylate, 2-hydroxyethyl methacrylate, 2- and 3-hydroxypropyl methacrylate, 4-hydroxybutyl methacrylate and monoethylenically unsaturated monomers having oligoalkylene oxide chains, preferably polyethylene oxide chains, having degrees of oligomerization which are preferably in the range from 2 to 200, e.g. monovinyl and monoallyl ethers of oligoethylene glycols and also esters of acrylic acid, maleic acid or methacrylic acid with oligoethylene glycols.

The proportion of monomers having acid groups is preferably not more than 10% by weight and in particular not more than 5% by weight, e.g. from 0.1 to 5% by weight, based on the monomers M. The proportion of hydroxyalkyl esters and monomers having oligoalkylene oxide chains is, if they are comprised, preferably in the range from 0.1 to 20% by weight and in particular in the range from 1 to 10% by weight, based on the monomers M. The proportion of amides and N-alkylolamides is, if they are comprised, preferably in the range from 0.1 to 5% by weight.

Apart from the abovementioned monomers B, it is also possible to use crosslinking monomers B such as glycidyl ethers and esters, e.g. vinyl, allyl and methallyl glycidyl ether, glycidyl acrylate and methacrylate, the diacetonylamides of the above-mentioned ethylenically unsaturated carboxylic acids, e.g. diacetone(meth)acrylamide, and the esters of acetylacetic acid with the abovementioned hydroxyalkyl esters of ethylenically unsaturated carboxylic acids, e.g. acetylacetoxyethyl(meth)acrylate, as further monomers B. Further possible monomers B are compounds which have two nonconjugated, ethylenically unsaturated bonds, e.g. the diesters and oligoesters of polyhydric alcohols with α,β-monoethylenically unsaturated C₃-C₁₀-monocarboxylic acids, for example alkylene glycol diacrylates and dimethacrylates, e.g. ethylene glycol diacrylate, 1,3-butylene glycol diacrylate, 1,4-butylene glycol diacrylate, propylene glycol diacrylate, and also divinylbenzene, vinyl methacrylate, vinyl acrylate, allyl methacrylate, allyl acrylate, diallyl maleate, diallyl fumarate, methylenebisacrylamide, cyclopentadienyl acrylate, tricyclodecenyl(meth)acrylate, N,N′-divinylimidazolin-2-one or triallyl cyanurate. The proportion of crosslinking monomers is generally not above 1% by weight, based on the total amount of monomers, and will in particular not exceed 0.1% by weight.

Further suitable monomers B are vinylsilanes, e.g. vinyltrialkoxysilanes. These are, if desired, used in an amount of from 0.01 to 1% by weight, based on the total amount of monomers in the preparation of the polymers.

Aqueous polymer dispersions can be obtained, in particular, by free-radically initiated aqueous emulsion polymerization of ethylenically unsaturated monomers. This method has previously been described many times and is therefore adequately known to those skilled in the art [cf. for example, Encyclopedia of Polymer Science and Engineering, Vol. 8, pages 659 to 677, John Wiley & Sons, Inc., 1987; D. C. Blackley, Emulsion Polymerisation, pages 155 to 465, Applied Science Publishers, Ltd., Essex, 1975; D. C. Blackley, Polymer Latices, 2nd Edition, Vol. 1, pages 33 to 415, Chapman & Hall, 1997; H. Warson, The Applications of Synthetic Resin Emulsions, pages 49 to 244, Ernest Benn, Ltd., London, 1972; D. Diederich, Chemie in unserer Zeit 1990, 24, pages 135 to 142, Verlag Chemie, Weinheim; J. Piirma, Emulsion Polymerisation, pages 1 to 287, Academic Press, 1982; F. Hölscher, Dispersionen synthetischer Hochpolymerer, pages 1 to 160, Springer-Verlag, Berlin, 1969 and the patent text DE-A 40 03 422]. The free-radically initiated aqueous emulsion polymerization is usually carried out by dispersing the ethylenically unsaturated monomers in an aqueous medium, frequently with concomitant use of surface-active substances, and polymerizing them by means of at least one free-radical polymerization initiator. The residual contents of unreacted monomers in the aqueous polymerization dispersions obtained are frequently reduced by chemical and/or physical methods which are likewise known to the those skilled in the art [see, for example, EP-A 771328, DE-A 19624299, DE-A 19621027, DE-A 19741184, DE-A 19741187, DE-A 19805122, DE-A 19828183, DE-A 19839199, DE-A 19840586 and 19847115], the content of polymer solids is set to a desired volume by dilution or concentration or further customary additives, for example bactericidal additives or antifoams, are added to the aqueous polymer dispersion. The contents of polymer solids in the aqueous polymer dispersions are frequently from 30 to 80% by weight, from 40 to 70% by weight or from 45 to 65% by weight. Preference is likewise given to the polymer powders produced from the polymer dispersions and also aqueous dispersions which are obtainable by redispersion of polymer powders in water. Both aqueous polymer dispersions and the powders produced therefrom are also commercially available, e.g. under the trade names ACRONAL®, STYRONAL®, BUTOFAN®, STYROFAN® and KOLLICOAT® from BASF-Aktiengesellschaft, Ludwigshafen, Germany, VINNOFIL® and VINNAPAS® from Wacker Chemie-GmbH, Burghausen, and RHODIMAX® from Rhodia S.A.

As surface-active substances for the emulsion polymerization, it is possible to use the emulsifiers and protective colloids which are customarily used for emulsion polymerization. Preferred emulsifiers are anionic and nonionic emulsifiers which, unlike the protective colloids, generally have a molecular weight below 2000 g/mol and are used in amounts of up to 0.2-10% by weight, preferably 0.5-5% by weight, based on the polymer in the dispersion or on the monomers M to be polymerized.

Such protective colloids have already been mentioned above by way of example for microcapsule formation.

Anionic emulsifiers include alkali metal and ammonium salts of alkylsulfates (alkyl radical: C₈-C₂₀), of sulfuric monoesters of ethoxylated alkanols (EO units: 2 to 50, alkyl radical: C₈ to C₂₀) and ethoxylated alkylphenols (EO units: 3 to 50, alkyl radical: C₄-C₂₀), of alkylsulfonic acids (alkyl radical: C₈ to C₂₀), of sulfonated mono- and di-C₆-C₁₈-alkyl(diphenyl ethers) as described in U.S. Pat. No. 4,269,749 and of alkylarylsulfonic acids (alkyl radical: C₄-C₂₀). Further suitable anionic emulsifiers may be found in Houben-Weyl, Methoden der organischen Chemie, Volume XIV/1, Makromolekulare Stolle, Georg-Thieme-Verlag, Stuttgart, 1961, pp. 192-208.

Suitable nonionic emulsifiers are araliphatic or aliphatic nonionic emulsifiers, for example ethoxylated monoalkylphenols, dialkylphenols and trialkylphenols (EO) units: 3 to 50, alkyl radical: C₄-C₉), ethoxylates of long-chain alcohols (EO units: 3 to 50, alkyl radical: C₈-C₃₆) and also polyethylene oxide-polypropylene oxide block copolymers. Preference is given to ethoxylates of long-chain alcohols (alkyl radical: C₁₀-C₂₂, mean degree of ethoxylation: 3 to 50) and among these particularly preferably those based on oxo alcohols and natural product alcohols having a linear or branched C₁₂-C₁₈-alkyl radical and a degree of ethoxylation of from 8 to 50.

The molecular weight of the polymers can of course be adjusted by addition of small amounts of regulators, generally up to 2% by weight, based on the polymerizing monomers M. Suitable regulators are, in particular, organic thio compounds, also allyl alcohols and aldehydes. In the preparation of butadiene-comprising polymers of class I, regulators, preferably organic thio compounds such as tert-dodecyl mercaptan, are frequently used in an amount of from 0.1 to 2% by weight.

After the polymerization is complete, the polymer dispersions used are frequently made alkaline, preferably to pH values in the range from 7 to 10, before they are used according to the invention. For the neutralization, it is possible to use ammonia or organic amines and also preferably hydroxides such as sodium hydroxide, potassium hydroxide or calcium hydroxide.

To produce polymer powders, the aqueous polymer dispersions are subjected in a known manner to a drying process, preferably in the presence of customary drying auxiliaries. A preferred drying method is spray drying. If required, the drying auxiliary is used in an amount of from 1 to 30% by weight, preferably from 2 to 20% by weight, based on the polymer content of the dispersion to be dried.

Spray drying of the polymer dispersions to be dried is generally carried out as described above for the microcapsule dispersion, often in the presence of a customary drying auxiliary such as homopolymers and copolymers of vinylpyrrolidone, homopolymers and copolymers of acrylic acid and/or of methacrylic acid with monomers bearing hydroxyl groups, vinylaromatic monomers, olefins and/or (meth)acrylic esters, polyvinyl alcohol and in particular arylsulfonic acid-formaldehyde condensation products and also mixtures thereof.

Furthermore, a customary anticaking agent such as a finely divided inorganic oxide, for example a finely divided silica or a finely divided silicate, e.g. talc, can be added during the drying process.

For particular uses of the coarsely particulate preparations according to the invention, water stability of the binder polymers is not necessary, for example in closed nonaqueous systems. In such cases, use is made of binder polymers which are water-soluble or partly water-soluble.

Natural polymeric binders such as starch and cellulose and also synthetic polymeric binders are suitable. Such binders are, for example, polyvinylpyrrolidone, polyvinyl alcohol or partially hydrolyzed polyvinyl acetate having a degree of hydrolysis of at least 60% and copolymers of vinyl acetate with vinylpyrrolidone, also graft polymers of polyvinyl acetate with polyethers, in particular ethylene oxide. Graft polymers of polyvinyl acetate with ethylene oxide have been found to be particularly advantageous. Such graft polymers are described, for example, in EP-A 1 124 541, whose teachings are expressly incorporated by reference.

Such polymers are also commercially available, e.g. under the trade names KOLLIDON® and KOLLICOAT® from BASF Aktiengesellschaft.

The coarsely particular preparation can be produced by bringing the microcapsules together with the polymeric binder and water into a coarsely particulate form, for example granulating or extruding them, and subsequently drying them. The binder can be added to the microcapsule powder. In a further embodiment, the binder can be added as spraying auxiliary during spray drying of the microcapsules. Such preferred binders are those mentioned above for spray drying of the microcapsules. They are usually added in an amount of from 1 to 10% by weight, based on the solids in the microcapsule dispersion. In these cases, the addition of further binder is possible but generally not necessary.

It is also possible to use the organic protective colloids used in the production of the microcapsules as binders. Addition of further binders is then generally not necessary. In this preferred variant, an oil-in-water emulsion is produced from 10-100% by weight of one or more C₁-C₂₄-alkyl esters of acrylic and/or methacrylic acid (monomers I), 0-80% by weight of a bifunctional or polyfunctional monomer (monomer II) which is insoluble or sparingly soluble in water and 0-90% by weight of other monomers (monomer III), in each case based on the total weight of the monomers, the latent heat storage material and the organic protective colloid, and the capsule wall is formed by free-radical polymerization, the resulting microcapsule dispersion is spray dried and brought into a coarsely particulate form.

The preparation can be produced by the methods known for agglomerates such as pellets, tablets and granules.

Agglomerates according to the invention can be obtained by movement of the microcapsule powder together with the binder in a drum or on suitable pans, known as pelletization pans. In drum granulation, the microcapsules continually migrate in an axial direction through a slightly inclined, rotating drum and are sprayed with the polymeric binder there. In pan granulation, the microcapsules are fed continuously via a metering device onto a pelletization pan, sprayed with the polymeric binder and after reaching a particular granule size run over the edge of the pan. Drum and pan granulation is particularly suitable for continuous operation and thus for large-volume products. Drying is advantageously carried out in a continuous fluidized-bed drier or a drum drier. In the case of batch processes, vacuum drying is also a possibility.

Furthermore, granules can also be produced in conventional fluidized-bed granulators. Here, the microcapsule powders which are kept in suspension by means of a hot air stream directed in an upward direction are sprayed in cocurrent or countercurrent with the polymeric binder dispersion and dried. This means that the polymeric binder is sprayed onto a fluidized powder. Fluidized-bed granulation is equally suitable for batch operation and continuous operation.

In one variant of fluidized-bed granulation, an aqueous microcapsule dispersion and an aqueous binder dispersion can be sprayed together or via two different nozzles into the granulator and dried there. This procedure has the advantage that the microcapsule dispersion does not have to be separately predried but can be granulated together with the binder dispersion.

Furthermore, granules can be produced by mixer granulation. Use is made of mixers which are provided with rigid or rotating internals (e.g. Diosna-Pharma mixer) and in the ideal case mix, granulate and dry in a single operation. The microcapsule powder is, with addition of the polymeric binder and if appropriate water, built up by the relocation unit to form granules. These are subsequently dried in fluidized-bed, convection or vacuum driers and comminuted by means of screening machines or mills. A vacuum rotary mixer drier, for example, is particularly gentle and dust-free.

In another embodiment, the microcapsules are extruded together with the polymeric binder.

The production of the coarsely particulate preparation is effected with addition of water and the polymeric binder. It is possible here to add the water to the microcapsule powder and/or binder powder. In a preferred embodiment, the microcapsule powder is mixed directly with a binder dispersion having the desired water content. The water content is 10-40% by weight, based on the total mixture. A lower water content generally leads to incomplete mixing of the two components and poor shapeability. Higher water contents are in principle possible, but above 50% by weight of water the mass can no longer be extruded but is runny. Preference is given to a water content of 20-35% by weight at the discharge point, since in this range the pellets obtained display good strength.

Suitable shaping methods are extruders such as single-screw or twin-screw extruders and melt calendering or melt tableting. Twin-screw extruders operate according to the principle of a mixing apparatus which simultaneously transports fluid to a die and compacts.

In a preferred embodiment, the product is compressed from the feed zone to the heating zone. In the middle zone of the extruder, the materials are dispersed and, if appropriate, degassed. In the end zone of the extruder, the mixture is discharged under pressure through a die.

Extrusion is carried out in the region of the glass transition temperature of the binder polymer and preferably below the softening or decomposition temperature of the microcapsule wall. The binder polymer should form a film under the process conditions, i.e. it should at least partly melt or soften but without becoming too fluid to shape the microcapsule wall. A suitable temperature range is the range from 25 K below to about 50 K above the glass transition temperature. The softening range of the binder polymer can, however, sometimes be decreased significantly by plasticizer or solvent defects, so that processing at up to 50 K below the glass transition temperature is also possible in the presence of these substances. Thus, when volatile plasticizers are used, these can be removed after the shaping process, as a result of which a greater strength is achieved. Since water is a plasticizer for polar polymers and the water-soluble, film-forming polymers, the adverse effect on the glass transition temperature of the pure polymer does not apply in these cases.

The die of the extruder can, depending on what is wanted, comprise one or more perforated plates or a flat nozzle or can have a more complex shape, for example tubular. Preference is given to dies which give particles whose ratio of surface area to volume obeys the following relationship:

$$\frac{\sqrt[2]{Surface area}}{\sqrt[3]{Volume}} \geq 2.5 .$$

Preferred dies have, for example, a cross or star shape, for example with 3, 4, 5 or 6 points.

In a preferred variant, the temperatures in the extruder are from 40 to 120° C. It is possible for a constant temperature to prevail. It is likewise possible for a temperature gradient from 40 up to 120° C. to prevail along the transport direction of the microcapsule/binder mixture. The gradient can have any type of steps ranging from continuous to stepwise. Agglomeration of these temperatures has the advantage that part of the water vaporizes during the mixing and/or compaction process.

Lubricants such as stearic acid are added during extrusion if appropriate.

Other additives used in the coarsely particulate microcapsule preparation can be: dyes, pigments, antistatics, agents for making the preparation hydrophilic and preferably graphite, in particular expanded graphite.

In a preferred embodiment, the preparation comprises from 2 to 20% by weight of graphite based on the total weight of the coarsely particulate preparation.

The production of expanded graphite and also products comprising expanded graphite is known from US-A 3 404 061. To produce expanded graphite, graphite intercalation compounds or graphite salts, e.g. graphite hydrogensulfate or graphite nitrate, are shock-heated. The graphite expandate formed comprises worm- or accordion-like aggregates.

Compaction of this graphite expandate under pressure enables self-supporting graphite films or plates to be produced without addition of binder. Comminution of such compacted or “precompacted” graphite expandate by means of cutter, impingement or jet mills then gives, depending on the degree of comminution, a powder or chopped pieces of precompacted graphite expandate. These powders can be mixed homogeneously in finely dispersed form into pressing compositions. As an alternative, graphite expandate can also be comminuted directly, i.e. without prior compaction, to give a powder which can be mixed into pressing compositions.

Powder or chopped pieces of compacted graphite expandate can be reexpanded if this is necessary for further use. Such a process is described in US-A 5 882 570. A reexpanded graphite powder (reexpandate) is obtained in this way.

In the following, the term “expanded graphite” is used as a collective term for (i) graphite expandate, (ii) powders or chopped pieces obtained by comminution of compacted graphite expandate, (iii) powder obtained by comminution of graphite expandate and (iv) reexpandate produced by reexpansion of comminuted compacted graphite expandate. All forms (i) to (iv) of expanded graphite are suitable additives to the coarsely particulate microcapsule preparation. Graphite expandate has a bulk density of from 2 to 20 g/l, comminuted graphite expandate has a bulk density of from 20 to 150 g/l, comminuted compacted graphite expandate has a bulk density of from 60 to 200 g/l and the reexpanded compacted graphite expandate has a bulk density of from 20 to 150 g/l.

In the case of expanded graphite having a mean particle size of about 5 μm, the specific surface area measured by the BET method is typically from 25 to 40 m²/g. Although the BET surface area of the expanded graphite decreases with increasing diameter of the particles, it continues to remain at a relatively high level. Thus, expanded graphite having a mean particle size of 5 mm always still has a BET surface area of more than 10 m²/g. Expanded graphite having mean particle sizes in the range from 5 μm to 5 mm is suitable for producing the particles according to the invention. Preference is given to expanded graphite having a mean particle size in the range from 5 μm to 5 mm, particularly preferably in the range from 50 μm to 1 mm.

The microcapsule preparations according to the invention have the latent heat storage material tightly enclosed, so that no emissions into the ambient air can be detected. This makes it possible for them to be used not only in closed systems but also in open systems.

The coarsely particulate microcapsule preparations as component A are very suitable for use in admixture with the framework component B. They display good hardness and are abrasion-resistant. Their coarsely particulate structure makes it possible for the store geometry to be chosen freely, for example beds in chemical reactors or columns and also in applications where flow through the beds occurs, e.g. heat exchangers.

Owing to the favorable ratio of surface area to interstices between the particles, it is possible for a large quantity of heat to be transferred and be removed quickly as a result of the ability of any carrier material such as air or water to flow through readily. Based on the volume of the preparation, the coarsely particulate microcapsules display a very high storage capacity and thus a very high efficiency. Compared to conventional heat stores, they have a lower space requirement and a lower store weight at the same storage performance.

In addition, the mixture of the invention comprises a framework component B. This comprises at least one porous metal organic framework comprising at least one at least bidentate organic compound coordinated to at least one metal ion. In addition, the component B can also comprise a plurality of different porous metal organic frameworks.

Such metal organic frameworks (MOFs) are known in the prior art and are described, for example, in U.S. Pat. No. 5,648,508, EP-A-0 790 253, M. O'Keeffe et al., J. Sol. State Chem., 152 (2000), pages 3 to 20, H. Li et al., Nature 402, (1999), page 276, M. Eddaoudi et al., Topics in Catalysis 9, (1999), pages 105 to 111, B. Chen et al., Science 291, (2001), pages 1021 to 1023, and DE-A-101 11 230.

A specific group of these metal organic frameworks which has been described in the recent literature is “limited” frameworks in which, due to a specific choice of the organic compound, the framework does not extend infinitely but instead forms polyhedra. A. C. Sudik, et al., J. Am. Chem. Soc. 127 (2005), 7110-7118, describes such specific frameworks. Here, these are referred to as metal organic polyhedra (MOPs) to distinguish them.

A further specific group of porous metal organic frameworks is those in which the organic compound as ligand is a monocyclic, bicyclic or polycyclic ring system which is derived from at least one heterocycle selected from the group consisting of pyrrole, alpha-pyridone and gamma-pyridone and has at least two ring nitrogens. The electrochemical preparation of such frameworks is described in WO-A 2007/131955 These specific groups are particularly suitable for the purposes of the present invention.

The metal organic frameworks according to the present invention comprise pores, in particular micropores and/or mesopores. Micropores are defined as pores having a diameter of 2 nm or less and mesopores are defined by a diameter in the range from 2 to 50 nm, in each case in accordance with the definition given in Pure & Applied Chem. 57 (1983), 603-619, in particular on page 606. The presence of micropores and/or mesopores can be checked by means of sorption measurements, with these measurements determining the uptake capacity of the MOF for nitrogen at 77 kelvin in accordance with DIN 66131 and/or DIN 66134.

The specific surface area, calculated according to the Langmuir model (DIN 66131, 66134), of an MOF in powder form is preferably more than 100 m²/g, more preferably above 300 m²/g, more preferably more than 700 m²/g, even more preferably more than 800 m²/g, even more preferably more than 1000 m²/g and particularly preferably more than 1200 m²/g.

Shaped bodies comprising metal organic frameworks can have a lower active surface area; but preferably more than 150 m²/g, more preferably more than 300 m²/g, even more preferably more than 700 m²/g.

The metal component in the framework according to the present invention is preferably selected from groups Ia, IIa, IIIa, IVa to VIIIa and Ib to VIb. Particular preference is given to Mg, Ca, Sr, Ba, Sc, Y, Ln, Ti, Zr, Hf, V, Nb, Ta, Cr, Mo, W, Mn, Re, Fe, Ro, Os, Co, Rh, Ir, Ni, Pd, Pt, Cu, Ag, Au, Zn, Cd, Hg, Al, Ga, In, TI, Si, Ge, Sn, Pb, As, Sb and Bi, where Ln represents lanthanides.

Lanthanides are La, Ce, Pr, Nd, Pm, Sm, En, Gd, Tb, Dy, Ho, Er, Tm, Yb.

With regard to ions of these elements, particular mentioned may be made of Mg²⁺, Ca²⁺, Sr²⁺, Ba²⁺, Sc³⁺, Y³⁺, Ln³⁺, Ti⁴⁺, Zr⁴⁺, Hf⁴⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe²⁺, Ru³⁺, Ru²⁺, Os³⁺, Os²⁺, Co³⁺, Co²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺, and Bi⁺.

Particular preference is also given to Mg, Al, Y, Sc, Zr, Ti, V, Cr, Mo, Fe, Co, Cu, Ni, Zn, Ln. Greater preference is given to Al, Mo, Y, Sc, Mg, Fe and Zn. Very particular preference is given to Al and Zn.

The term “at least bidentate organic compound” refers to an organic compound which comprises at least one functional group which is able to form at least two, coordinate bonds to a given metal ion and/or form a coordinate bond to each of two or more, preferably two, metal atoms.

As functional groups via which the abovementioned coordinate bonds can be formed, mention may be made by way of example of, in particular: —CO₂H, —CS₂H, —NO₂, —B(OH)₂, —SO₃H, —Si(OH)₃, —Ge(OH)₃, —Sn(OH)₃, —Si(SH)₄, —Ge(SH)₄, —Sn(SH)₃, —PO₃H, —AsO₃H, —AsO₄H, —P(SH)₃, —As(SH)₃, —CH(RSH)₂, —C(RSH)₃, —CH(RNH₂)₂, —C(RNH₂)₃, —CH(ROH)₂, —C(ROH)₃, —CH(RCN)₂, —C(RCN)₃, where R is preferably, for example, an alkylene group having 1, 2, 3, 4 or 5 carbon atoms, for example a methylene, ethylene, n-propylene, i-propylene, n-butylene, i-butylene, tert-butylene or n-pentylene group, or an aryl group comprising 1 or 2 aromatic rings, for example 2 C₆ rings, which may, if appropriate, be fused and may, independently of one another, be appropriately substituted by in each case at least one substituent and/or may, independently of one another comprise in each case at least one heteroatom, for example N, O and/or S. In likewise preferred embodiments, mention may be made of functional groups in which the abovementioned radical R is not present. In this regard, mention may be made of, inter alia, —CH(SH)₂, —C(SH)₃, —CH(NH₂)₂, —C(NH₂)₃, —CH(OH)₂, —C(OH)₃, —CH(CN)₂ or —C(CN)₃.

However, the functional groups can also be heteroatoms of a heterocycle. Particular mention may here be made of nitrogen atoms.

The at least two functional groups can in principle be bound to any suitable organic compound as long as it is ensured that the organic compound comprising these functional groups is capable of forming the coordinate bond and of producing the framework.

The organic compounds which comprise at least two functional groups are preferably derived from a saturated or unsaturated aliphatic compound or an aromatic compound or a both aliphatic and aromatic compound.

The aliphatic compound or the aliphatic part of the both aliphatic and aromatic compound can be linear and/or branched and/or cyclic, with a plurality of rings per compound also being possible. The aliphatic compound or the aliphatic part of the both aliphatic and aromatic compound more preferably comprises from 1 to 15, more preferably from 1 to 14, more preferably from 1 to 13, more preferably from 1 to 12, more preferably from 1 to 11 and particularly preferably from 1 to 10, carbon atoms, for example 1, 2, 3, 4, 5, 6, 7, 8, 9 or 10 carbon atoms. Particular preference is here given to, inter alia, methane, adamantane, acetylene, ethylene or butadiene.

The aromatic compound or the aromatic part of the both aromatic and aliphatic compound can have one or more rings, for example two, three, four or five rings, with the rings being able to be present separately from one another and/or at least two rings can be present in fused form. The aromatic compound or the aromatic part of the both aliphatic and aromatic compound particularly preferably has one, two or three rings, with particular preference being given to one or two rings. Furthermore, the rings of said compound can each comprise, independently of one another, at least one heteroatom such as N, O, S, B, P, Si, Al, preferably N, O and/or S. More preferably, the aromatic compound or the aromatic part of the both aromatic and aliphatic compound comprises one or two C₆ rings; in the case of two rings, they can be present either separately from one another or in fused form. Aromatic compounds of which particular mention may be made are benzene, naphthalene and/or biphenyl and/or bipyridyl and/or pyridyl.

The at least bidentate organic compound is more preferably an aliphatic or aromatic, acyclic or cyclic hydrocarbon which has from 1 to 18, preferably from 1 to 10 and in particular 6, carbon atoms and also has exclusively 2, 3 or 4 carboxyl groups as functional groups

For example, the at least bidentate organic compound is derived from a dicarboxylic acid such as oxalic acid, succinic acid, tartaric acid, 1,4-butanedicarboxylic acid, 1,4-butanedicarboxylic acid, 4-oxopyran-2,6-dicarboxylic acid, 1,6-hexanedicarboxylic acid, decanedicarboxylic acid, 1,8-heptadecanedicarboxylic acid, 1,9-heptadecanedicarboxylic acid, heptadecanedicarboxylic acid, acetylenedicarboxylic acid, 1,2-benzenedicarboxylic acid, 1,3-benzenedicarboxylic acid, 2,3-pyridinedicarboxylic acid, pyridine-2,3-dicarboxylic acid, 1,3-butadiene-1,4-dicarboxylic acid, 1,4-benzenedicarboxylic acid, p-benzenedicarboxylic acid, imidazole-2,4-dicarboxylic acid, 2-methylquinoline-3,4-dicarboxylic acid, quinoline-2,4-dicarboxylic acid, quinoxaline-2,3-dicarboxylic acid, 6-chloroquinoxaline-2,3-dicarboxylic acid, 4,4′-diaminophenylmethane-3,3′-dicarboxylic acid, quinoline-3,4-dicarboxylic acid, 7-chloro-4-hydroxyquinoline-2,8-dicarboxylic acid, diimidedicarboxylic acid, pyridine-2,6-dicarboxylic acid, 2-methylimidazole-4,5-dicarboxylic acid, thiophene-3,4-dicarboxylic acid, 2-isopropylimidazole-4,5-dicarboxylic acid, tetrahydropyran-4,4-dicarboxylic acid, perylene-3,9-dicarboxylic acid, perylenedicarboxylic acid, Pluriol E 200-dicarboxylic acid, 3,6-dioxaoctanedicarboxylic acid, 3,5-cyclohexadiene-1,2-dicarboxylic acid, octadicarboxylic acid, pentane-3,3-carboxylic acid, 4,4′-diamino-1,1′-biphenyl-3,3′-dicarboxylic acid, 4,4′-diaminobiphenyl-3,3′-dicarboxylic acid, benzidine-3,3′-dicarboxylic acid, 1,4-bis(phenylamino)benzene-2,5-dicarboxylic acid, 1,1′-binaphthyldicarboxylic acid, 7-chloro-8-methylquinoline-2,3-dicarboxylic acid, 1-anilinoanthraquinone-2,4′-dicarboxylic acid, polytetrahydrofuran-250-dicarboxylic acid, 1,4-bis(carboxymethyl)piperazine-2,3-dicarboxylic acid, 7-chloroquinoline-3,8-dicarboxylic acid, 1-(4-carboxy)phenyl-3-(4-chloro)phenylpyrazoline-4,5-dicarboxylic acid, 1,4,5,6,7,7-hexachloro-5-norbornene-2,3-dicarboxylic acid, phenylindane-dicarboxylic acid, 1,3-dibenzyl-2-oxoimidazolidine-4,5-dicarboxylic acid, 1,4-cyclohexanedicarboxylic acid, naphthalene-1,8-dicarboxylic acid, 2-benzoylbenzene-1,3-dicarboxylic acid, 1,3-dibenzyl-2-oxoimidazolidine-4,5-cis-dicarboxylic acid, 2,2′-biquinoline-4,4′-dicarboxylic acid, pyridine-3,4-dicarboxylic acid, 3,6,9-trioxaundecanedicarboxylic acid, hydroxybenzophenonedicarboxylic acid, Pluriol E 300-dicarboxylic acid, Pluriol E 400-dicarboxylic acid, Pluriol E 600-dicarboxylic acid, pyrazole-3,4-dicarboxylic acid, 2,3-pyrazinedicarboxylic acid, 5,6-dimethyl-2,3-pyrazinedicarboxylic acid, (bis(4-aminophenyl)ether)diimidedicarboxylic acid, 4,4′-diaminodiphenylmethanediimidedicarboxylic acid, (bis(4-aminophenyl)sulfone)diimidedicarboxylic acid, 1,4-naphthalenedicarboxylic acid, 2,6-naphthalenedicarboxylic acid, 1,3-adamantanedicarboxylic acid, 1,8-naphthalenedicarboxylic acid, 2,3-naphthalenedicarboxylic acid, 8-methoxy-2,3-naphthalenedicarboxylic acid, 8-nitro-2,3-naphthalenecarboxylic acid, 8-sulfo-2,3-naphthalenedicarboxylic acid, anthracene-2,3-dicarboxylic acid, 2′,3′-diphenyl-p-terphenyl-4,4″-dicarboxylic acid, (diphenyl ether)-4,4′-dicarboxylic acid, imidazole-4,5-dicarboxylic acid, 4(1H)-oxothiochromene-2,8-dicarboxylic acid, 5-tert-butyl-1,3-benzenedicarboxylic acid, 7,8-quinolinedicarboxylic acid, 4,5-imidazoledicarboxylic acid, 4-cyclohexene-1,2-dicarboxylic acid, hexatriacontanedicarboxylic acid, tetradecanedicarboxylic acid, 1,7-heptadicarboxylic acid, 5-hydroxy-1,3-benzenedicarboxylic acid, 2,5-dihydroxy-1,4-dicarboxylic acid, pyrazine-2,3-dicarboxylic acid, furan-2,5-dicarboxylic acid, 1-nonene-6,9-dicarboxylic acid, eicosenedicarboxylic acid, 4,4′-dihydroxydiphenylmethane-3,3′-dicarboxylic acid, 1-amino-4-methyl-9,10-dioxo-9,10-dihydroanthracene-2,3-dicarboxylic acid, 2,5-pyridinedicarboxylic acid, cyclohexene-2,3-dicarboxylic acid, 2,9-dichlorofluorubin-4,11-dicarboxylic acid, 7-chloro-3-methylquinoline-6,8-dicarboxylic acid, 2,4-dichlorobenzophenone-2′,5′-dicarboxylic acid, 1,3-benzenedicarboxylic acid, 2,6-pyridinedicarboxylic acid, 1-methylpyrrole-3,4-dicarboxylic acid, 1-benzyl-1H-pyrrole-3,4-dicarboxylic acid, anthraquinone-1,5-dicarboxylic acid, 3,5-pyrazoledicarboxylic acid, 2-nitrobenzene-1,4-dicarboxylic acid, heptane-1,7-dicarboxylic acid, cyclobutane-1,1-dicarboxylic acid, 1,14-tetradecanedicarboxylic acid, 5,6-dehydronorbornane-2,3-dicarboxylic acid, 5-ethyl-2,3-pyridinedicarboxylic acid or camphordicarboxylic acid.

The at least bidentate organic compound is more preferably one of the dicarboxylic acids mentioned above by way of example as such.

For example, the at least bidentate organic compound can be derived from a tricarboxylic acid such as

2-hydroxy-1,2,3-propanetricarboxylic acid, 7-chloro-2,3,8-quinolinetricarboxylic acid, 1,2,3-, 1,2,4-benzenetricarboxylic acid, 1,2,4-butanetricarboxylic acid, 2-phosphono-1,2,4-butanetricarboxylic acid, 1,3,5-benzenetricarboxylic acid, 1-hydroxy-1,2,3-propanetricarboxylic acid, 4,5-dihydro-4,5-dioxo-1H-pyrrolo[2,3-F]quinoline-2,7,9-tricarboxylic acid, 5-acetyl-3-amino-6-methylbenzene-1,2,4-tricarboxylic acid, 3-amino-5-benzoyl-6-methylbenzene-1,2,4-tricarboxylic acid, 1,2,3-propanetricarboxylic acid or aurintricarboxylic acid.

The at least bidentate organic compound is more preferably one of the tricarboxylic acids mentioned above by way of example as such.

Examples of an at least bidentate organic compound which is derived from a tetracarboxylic acid are

1,1-dioxidoperylo[1,12-BCD]thiophene-3,4,9,10-tetracarboxylic acid, perylenetetracarboxylic acids such as perylene-3,4,9,10-tetracarboxylic acid or (perylene 1,12-sulfone)-3,4,9,10-tetracarboxylic acid, butanetetracarboxylic acids such as 1,2,3,4-butanetetracarboxylic acid or meso-1,2,3,4-butanetetracarboxylic acid, decane-2,4,6,8-tetracarboxylic acid, 1,4,7,10,13,16-hexaoxacyclooctadecane-2,3,11,12-tetracarboxylic acid, 1,2,4,5-benzenetetracarboxylic acid, 1,2,11,12-dodecanetetracarboxylic acid, 1,2,5,6-hexanetetracarboxylic acid, 1,2,7,8-octanetetracarboxylic acid, 1,4,5,8-naphthalenetetracarboxylic acid, 1,2,9,10-decanetetracarboxylic acid, benzophenonetetracarboxylic acid, 3,3′,4,4′-benzophenonetetracarboxylic acid, tetrahydrofurantetracarboxylic acid or cyclopentanetetracarboxylic acids such as cyclopentane-1,2,3,4-tetracarboxylic acid.

The at least bidentate organic compound is more preferably one of the tetracarboxylic acids mentioned above by way of example as such.

Preferred heterocycles as at least bidentate organic compounds in which a coordinate bond is formed via the heteroatoms of the ring are the following substituted or unsubstituted ring systems:

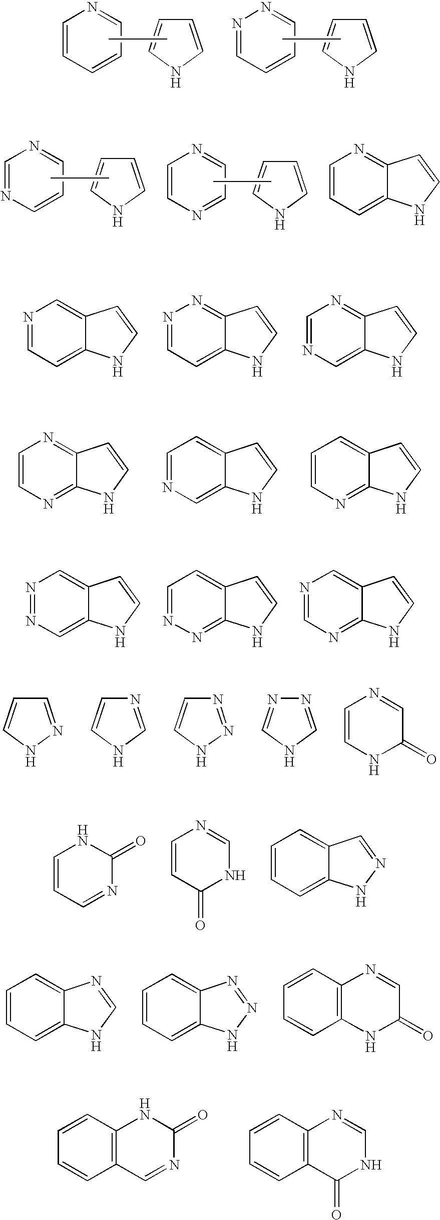

Very particular preference is given to using optionally at least monosubstituted aromatic dicarboxylic, tricarboxylic or tetracarboxylic acids which have one, two, three, four or more rings and in which each of the rings can comprise at least one heteroatom, with two or more rings being able to comprise identical or different heteroatoms. For example, preference is given to one-ring dicarboxylic acids, one-ring tricarboxylic acids, one-ring tetracarboxylic acids, two-ring dicarboxylic acids, two-ring tricarboxylic acids, two-ring tetracarboxylic acids, three-ring dicarboxylic acids, three-ring tricarboxylic acids, three-ring tetracarboxylic acids, four-ring dicarboxylic acids, four-ring tricarboxylic acids and/or four-ring tetracarboxylic acids. Suitable heteroatoms are, for example, N, O, S, B, P and preferred heteroatoms here are N, S and/or O, Suitable substituents which may be mentioned in this respect are, inter alia, —OH, a nitro group, an amino group or an alkyl or alkoxy group.

Particular preference is given to using 2-methylimidazolate, acetylenedicarboxylic acid (ADC), camphordicarboxylic acid, fumaric acid, succinic acid, benzenedicarboxylic acids such as phthalic acid, isophthalic acid, terephthalic acid (BDC), aminoterephthalic acid, triethienediamine (TEDA), naphthalenedicarboxylic acids (NDC)-, biphenyldicarboxylic acids such as 4,4′-biphenyldicarboxylic acid (BPDC), pyrazinedicarboxylic acids such as 2,5-pyrazinedicarboxylic acid, bipyridinedicarboxylic acids such as 2,2′-bipyridinedicarboxylic acids such as 2,2′-bipyridine-5,5′-dicarboxylic acid, benzenetricarboxylic acids such as 1,2,3-, 1,2,4-benzenetricarboxylic acid or 1,3,5-benzenetricarboxylic acid (BTC), benzenetetracarboxylic acid, adamantane-tetracarboxylic acid (ATC), adamantanedibenzoate (ADB), benzenetribenzoate (BTB), methanetetrabenzoate (MTB), adamantanetetrabenzoate or dihydroxyterephthalic acids such as 2,5-dihydroxyterephthalic acid (DHBDC) as at least bidentate organic compounds.

Very particular preference is given to, inter alia, 2-methylimidazole, 2-ethylimidazole, phthalic acid, isophthalic acid, terephthalic acid, 2,6-naphthalenedicarboxylic acid, 1,4-naphthalenedicarboxylic acid, 1,5-naphthalenedicarboxylic acid, 1,2,3-benzenetricarboxylic acid, 1,2,4-benzenetricarboxylic acid, 1,3,5-benzenetricarboxylic acid, 1,2,4,5-benzenetetracarboxylic acid, aminoBDC, TEDA, fumaric acid, biphenyldicarboxylate, 1,5- and 2,6-naphthalenedicarboxylic acid, tert-butylisophthalic acid, dihydroxybenzoic acid.

In addition to these at least bidentate organic compounds, the metal organic framework can further comprise one or more monodentate ligands and/or one or more at least bidentate ligands which are not derived from a dicarboxylic, tricarboxylic or tetracarboxylic acid.

In addition to these at least bidentate organic compounds, the MOF can further comprise one or more monodentate ligands.

Suitable solvents for preparing the MOFs are, inter alia, ethanol, dimethylformamide, toluene, methanol, chlorobenzene, diethylformamide, dimethyl sulfoxide, water, hydrogen peroxide, methylamine, sodium hydroxide solution, N-methylpyrrolidone ether, acetonitrile, benzyl chloride, triethylamine, ethylene glycol and mixtures thereof. Further metal ions, at least bidentate organic compounds and solvents for preparing MOFs are described, inter alia, in U.S. Pat. No. 5,648,508 or DE-A 101 11 230.

The pore size of the metal organic framework can be controlled by selection of the appropriate ligand and/or the at least bidentate organic compound. It is generally the case that the larger the organic compound, the larger the pore size. The pore size is preferably from 0.2 nm to 30 nm, particularly preferably in the range from 0.3 nm to 3 nm, based on the crystalline material.

However, larger pores whose size distribution can vary also occur in a shaped MOF body. However, preference is given to more than 50% of the total pore volume, in particular more than 75%, being made up by pores having a pore diameter of up to 1000 nm. However, a large part of the pore volume is preferably made up by pores having two different diameter ranges. It is therefore more preferred for more than 25% of the total pore volume, in particular more than 50% of the total pore volume, to be made up by pores which are in a diameter range from 100 nm to 800 nm and for more than 15% of the total pore volume, in particular more than 25% of the total pore volume, to be made up by pores which are in a diameter range up to 10 nm. The pore distribution can be determined by means of mercury porosimetry.

Examples of metal organic frameworks are given below. In addition to the designation of the MOF, the metal and the at least bidentate ligand, the solvent and the cell parameters (angles α, β and γ and the dimensions A, B and C in A) are indicated. The latter were determined by X-ray diffraction.

| | Constituents | | | | | | | | |
|---|---|---|---|---|---|---|---|---|---|
| | molar ratio | | | | | | | | Space |
| MOF-n | M + L | Solvents | α | β | γ | a | b | c | group |
| MOF-0 | Zn(NO₃)₂•6H₂O | ethanol | 90 | 90 | 120 | 16.711 | 16.711 | 14.189 | P6(3)/ |
| | H₃(BTC) | | | | | | | | Mcm |
| MOF-2 | Zn(NO₃)₂•6H₂O | DMF | 90 | 102.8 | 90 | 6.718 | 15.49 | 12.43 | P2(1)/n |
| | (0.246 mmol) | toluene | | | | | | | |
| | H₂(BDC) | | | | | | | | |
| | 0.241 mmol) | | | | | | | | |
| MOF-3 | Zn(NO₃)₂•6H₂O | DMF | 99.72 | 111.11 | 108.4 | 9.726 | 9.911 | 10.45 | P-1 |
| | (1.89 mmol) | MeOH | | | | | | | |
| | H₂(BDC) | | | | | | | | |
| | (1.93 mmol) | | | | | | | | |
| MOF-4 | Zn(NO₃)₂•6H₂O | ethanol | 90 | 90 | 90 | 14.728 | 14.728 | 14.728 | P2(1)3 |
| | (1.00 mmol) | | | | | | | | |
| | H₃(BTC) | | | | | | | | |
| | (0.5 mmol) | | | | | | | | |
| MOF-5 | Zn(NO₃)₂•6H₂O | DMF | 90 | 90 | 90 | 25.669 | 25.669 | 25.669 | Fm-3m |
| | (2.22 mmol) | chloro- | | | | | | | |
| | H₂(BDC) | benzene | | | | | | | |
| | (2.17 mmol) | | | | | | | | |
| MOF-38 | Zn(NO₃)₂•6H₂O | DMF | 90 | 90 | 90 | 20.657 | 20.657 | 17.84 | I4cm |
| | (0.27 mmol) | chloro- | | | | | | | |
| | H₃(BTC) | benzene | | | | | | | |
| | (0.15 mmol) | | | | | | | | |
| MOF-31 | Zn(NO₃)₂•6H₂O | ethanol | 90 | 90 | 90 | 10.821 | 10.821 | 10.821 | Pn(-3)m |
| Zn(ADC)₂ | 0.4 mmol | | | | | | | | |
| | H₂(ADC) | | | | | | | | |
| | 0.8 mmol | | | | | | | | |
| MOF-12 | Zn(NO₃)₂•6H₂O | ethanol | 90 | 90 | 90 | 15.745 | 16.907 | 18.167 | Pbca |
| Zn₂(ATC) | 0.3 mmol | | | | | | | | |
| | H₄(ATC) | | | | | | | | |
| | 0.15 mmol | | | | | | | | |
| MOF-20 | Zn(NO₃)₂•6H₂O | DMF | 90 | 92.13 | 90 | 8.13 | 16.444 | 12.807 | P2(1)/c |
| ZnNDC | 0.37 mmol | chloro- | | | | | | | |
| | H₂NDC | benzene | | | | | | | |
| | 0.36 mmol | | | | | | | | |
| MOF-37 | Zn(NO₃)₂•6H₂O | DEF | 72.38 | 83.16 | 84.33 | 9.952 | 11.576 | 15.556 | P-1 |
| | 0.2 mmol | chloro- | | | | | | | |
| | H₂NDC | benzene | | | | | | | |
| | 0.2 mmol | | | | | | | | |
| MOF-8 | Tb(NO₃)₃•5H₂O | DMSO | 90 | 115.7 | 90 | 19.83 | 9.822 | 19.183 | C2/c |
| Tb₂ (ADC) | 0.10 mmol | MeOH | | | | | | | |
| | H₂ADC | | | | | | | | |
| | 0.20 mmol | | | | | | | | |
| MOF-9 | Tb(NO₃)₃•5H₂O | DMSO | 90 | 102.09 | 90 | 27.056 | 16.795 | 28.139 | C2/c |
| Tb₂ (ADC) | 0.08 mmol | | | | | | | | |
| | H₂ADB | | | | | | | | |
| | 0.12 mmol | | | | | | | | |
| MOF-6 | Tb(NO₃)₃•5H₂O | DMF | 90 | 91.28 | 90 | 17.599 | 19.996 | 10.545 | P21/c |
| | 0.30 mmol | MeOH | | | | | | | |
| | H₂ (BDC) | | | | | | | | |
| | 0.30 mmol | | | | | | | | |
| MOF-7 | Tb(NO₃)₃•5H₂O | H₂O | 102.3 | 91.12 | 101.5 | 6.142 | 10.069 | 10.096 | P-1 |
| | 0.15 mmol | | | | | | | | |
| | H₂(BDC) | | | | | | | | |
| | 0.15 mmol | | | | | | | | |
| MOF-69A | Zn(NO₃)₂•6H₂O | DEF | 90 | 111.6 | 90 | 23.12 | 20.92 | 12 | C2/c |
| | 0.083 mmol | H₂O₂ | | | | | | | |
| | 4,4′BPDC | MeNH₂ | | | | | | | |
| | 0.041 mmol | | | | | | | | |
| MOF-69B | Zn(NO₃)₂•6H₂O | DEF | 90 | 95.3 | 90 | 20.17 | 18.55 | 12.16 | C2/c |
| | 0.083 mmol | H₂O₂ | | | | | | | |
| | 2,6-NCD | MeNH₂ | | | | | | | |
| | 0.041 mmol | | | | | | | | |
| MOF-11 | Cu(NO₃)₂•2.5H₂O | H₂O | 90 | 93.86 | 90 | 12.987 | 11.22 | 11.336 | C2/c |
| Cu₂(ATC) | 0.47 mmol | | | | | | | | |
| | H₂ATC | | | | | | | | |
| | 0.22 mmol | | | | | | | | |
| MOF-11 | | | 90 | 90 | 90 | 8.4671 | 8.4671 | 14.44 | P42/ |
| CU₂(ATC) | | | | | | | | | mmc |
| dehydr. | | | | | | | | | |
| MOF-14 | Cu(NO₃)₂•2.5H₂O | H₂O | 90 | 90 | 90 | 26.946 | 26.946 | 26.946 | Im-3 |
| Cu₃ (BTB) | 0.28 mmol | DMF | | | | | | | |
| | H₃BTB | EtOH | | | | | | | |
| | 0.052 mmol | | | | | | | | |
| MOF-32 | Cd(NO₃)₂•4H₂O | H₂O | 90 | 90 | 90 | 13.468 | 13.468 | 13.468 | P(-4)3m |
| Cd(ATC) | 0.24 mmol | NaOH | | | | | | | |
| | H₄ATC | | | | | | | | |
| | 0.10 mmol | | | | | | | | |
| MOF-33 | ZnCl₂ | H₂O | 90 | 90 | 90 | 19.561 | 15.255 | 23.404 | Imma |
| Zn₂ (ATB) | 0.15 mmol | DMF | | | | | | | |
| | H₄ATB | EtOH | | | | | | | |
| | 0.02 mmol | | | | | | | | |
| MOF-34 | Ni(NO₃)₂•6H₂O | H₂O | 90 | 90 | 90 | 10.066 | 11.163 | 19.201 | P2₁2₁2₁ |
| Ni(ATC) | 0.24 mmol | NaOH | | | | | | | |
| | H₄ATC | | | | | | | | |
| | 0.10 mmol | | | | | | | | |
| MOF-36 | Zn(NO₃)₂•4H₂O | H₂O | 90 | 90 | 90 | 15.745 | 16.907 | 18.167 | Pbca |
| Zn₂ (MTB) | 0.20 mmol | DMF | | | | | | | |
| | H₄MTB | | | | | | | | |
| | 0.04 mmol | | | | | | | | |
| MOF-39 | Zn(NO₃)₂ 4H₂O | H₂O | 90 | 90 | 90 | 17.158 | 21.591 | 25.308 | Pnma |
| Zn₃O(HBTB) | 0.27 mmol | DMF | | | | | | | |
| | H₃BTB | EtOH | | | | | | | |
| | 0.07 mmol | | | | | | | | |
| NO305 | FeCl₂•4H₂O | DMF | 90 | 90 | 120 | 8.2692 | 8.2692 | 63.566 | R-3c |
| | 5.03 mmol | | | | | | | | |
| | formic acid | | | | | | | | |
| | 86.90 mmol | | | | | | | | |
| NO306A | FeCl₂•4H₂O | DEF | 90 | 90 | 90 | 9.9364 | 18.374 | 18.374 | Pbcn |
| | 5.03 mmol | | | | | | | | |
| | formic acid | | | | | | | | |
| | 86.90 mmol | | | | | | | | |
| NO29 | Mn(Ac)₂•4H₂O | DMF | 120 | 90 | 90 | 14.16 | 33.521 | 33.521 | P-1 |
| MOF-0 | 0.46 mmol | | | | | | | | |
| similar | H₃BTC | | | | | | | | |
| | 0.69 mmol | | | | | | | | |
| BPR48 | Zn(NO₃)₂ 6H₂O | DMSO | 90 | 90 | 90 | 14.5 | 17.04 | 18.02 | Pbca |
| A2 | 0.012 mmol | toluene | | | | | | | |
| | H₂BDC | | | | | | | | |
| | 0.012 mmol | | | | | | | | |
| BPR69 | Cd(NO₃)₂ 4H₂O | DMSO | 90 | 98.76 | 90 | 14.16 | 15.72 | 17.66 | Cc |
| B1 | 0.0212 mmol | | | | | | | | |
| | H₂BDC | | | | | | | | |
| | 0.0428 mmol | | | | | | | | |
| BPR92 | Co(NO₃)₂•6H₂O | NMP | 106.3 | 107.63 | 107.2 | 7.5308 | 10.942 | 11.025 | P1 |
| A2 | 0.018 mmol | | | | | | | | |
| | H₂BDC | | | | | | | | |
| | 0.018 mmol | | | | | | | | |
| BPR95 | Cd(NO₃)₂ 4H₂O | NMP | 90 | 112.8 | 90 | 14.460 | 11.085 | 15.829 | P2(1)/n |
| C5 | 0.012 mmol | | | | | | | | |
| | H₂BDC | | | | | | | | |
| | 0.36 mmol | | | | | | | | |
| Cu C₆H₄O₆ | Cu(NO₃)₂•2.5H₂O | DMF | 90 | 105.29 | 90 | 15.259 | 14.816 | 14.13 | P2(1)/c |
| | 0.370 mmol | chloro- | | | | | | | |
| | H₂BDC(OH)₂ | benzene | | | | | | | |
| | 0.37 mmol | | | | | | | | |
| M(BTC) | Co(SO₄) H₂O | DMF | as for MOF-0 | | | | | | |
| MOF-0 | 0.055 mmol | | | | | | | | |
| similar | H₃BTC | | | | | | | | |
| | 0.037 mmol | | | | | | | | |
| Tb(C₆H₄O₆) | Tb(NO₃)₃•5H₂O | DMF | 104.6 | 107.9 | 97.147 | 10.491 | 10.981 | 12.541 | P-1 |
| | 0.370 mmol | chloro- | | | | | | | |
| | H₂(C₆H₄O₆) | benzene | | | | | | | |
| | 0.56 mmol | | | | | | | | |
| Zn (C₂O₄) | ZnCl₂ | DMF | 90 | 120 | 90 | 9.4168 | 9.4168 | 8.464 | P(-3)1m |
| | 0.370 mmol | chloro- | | | | | | | |
| | oxalic acid | benzene | | | | | | | |
| | 0.37 mmol | | | | | | | | |
| Co(CHO) | Co(NO₃)₂•5H₂O | DMF | 90 | 91.32 | 90 | 11.328 | 10.049 | 14.854 | P2(1)/n |
| | 0.043 mmol | | | | | | | | |
| | formic acid | | | | | | | | |
| | 1.60 mmol | | | | | | | | |
| Cd(CHO) | Cd(NO₃)₂•4H₂O | DMF | 90 | 120 | 90 | 8.5168 | 8.5168 | 22.674 | R-3c |
| | 0.185 mmol | | | | | | | | |
| | formic acid | | | | | | | | |
| | 0.185 mmol | | | | | | | | |
| Cu(C₃H₂O₄) | Cu(NO₃)₂•2.5H₂O | DMF | 90 | 90 | 90 | 8.366 | 8.366 | 11.919 | P43 |
| | 0.043 mmol | | | | | | | | |
| | malonic acid | | | | | | | | |
| | 0.192 mmol | | | | | | | | |
| Zn₆ (NDC)₅ | Zn(NO₃)₂•6H₂O | DMF | 90 | 95.902 | 90 | 19.504 | 16.482 | 14.64 | C2/m |
| MOF-48 | 0.097 mmol | chloro- | | | | | | | |
| | 14 NDC | benzene | | | | | | | |
| | 0.069 mmol | H₂O₂ | | | | | | | |
| MOF-47 | Zn(NO₃)₂ 6H₂O | DMF | 90 | 92.55 | 90 | 11.303 | 16.029 | 17.535 | P2(1)/c |
| | 0.185 mmol | chloro- | | | | | | | |
| | H₂(BDC[CH₃]₄) | benzene | | | | | | | |
| | 0.185 mmol | H₂O₂ | | | | | | | |
| MO25 | Cu(NO₃)₂•2.5H₂O | DMF | 90 | 112.0 | 90 | 23.880 | 16.834 | 18.389 | P2(1)/c |
| | 0.084 mmol | | | | | | | | |
| | BPhDC | | | | | | | | |
| | 0.085 mmol | | | | | | | | |
| Cu-thio | Cu(NO₃)₂•2.5H₂O | DEF | 90 | 113.6 | 90 | 15.4747 | 14.514 | 14.032 | P2(1)/c |
| | 0.084 mmol | | | | | | | | |
| | thiophene | | | | | | | | |
| | dicarboxylic acid | | | | | | | | |
| | 0.085 mmol | | | | | | | | |
| ClBDC1 | Cu(NO₃)₂•2.5H₂O | DMF | 90 | 105.6 | 90 | 14.911 | 15.622 | 18.413 | C2/c |
| | 0.084 mmol | | | | | | | | |
| | H₂(BDCCl₂) | | | | | | | | |
| | 0.085 mmol | | | | | | | | |
| MOF-101 | Cu(NO₃)₂•2.5H₂O | DMF | 90 | 90 | 90 | 21.607 | 20.607 | 20.073 | Fm3m |
| | 0.084 mmol | | | | | | | | |
| | BrBDC | | | | | | | | |
| | 0.085 mmol | | | | | | | | |
| Zn₃(BTC)₂ | ZnCl₂ | DMF | 90 | 90 | 90 | 26.572 | 26.572 | 26.572 | Fm-3m |
| | 0.033 mmol | EtOH | | | | | | | |
| | H₃BTC | base | | | | | | | |
| | 0.033 mmol | added | | | | | | | |
| MOF-j | Co(CH₃CO₂)₂•4H₂O | H₂O | 90 | 112.0 | 90 | 17.482 | 12.963 | 6.559 | C2 |
| | (1.65 mmol) | | | | | | | | |
| | H₃(BZC) | | | | | | | | |
| | (0.95 mmol) | | | | | | | | |
| MOF-n | Zn(NO₃)₂•6H₂O | ethanol | 90 | 90 | 120 | 16.711 | 16.711 | 14.189 | P6(3)/mcm |
| | H₃ (BTC) | | | | | | | | |
| PbBDC | Pb(NO₃)₂ | DMF | 90 | 102.7 | 90 | 8.3639 | 17.991 | 9.9617 | P2(1)/n |
| | (0.181 mmol) | ethanol | | | | | | | |
| | H₂(BDC) | | | | | | | | |
| | (0.181 mmol) | | | | | | | | |
| Znhex | Zn(NO₃)₂•6H₂O | DMF | 90 | 90 | 120 | 37.1165 | 37.117 | 30.019 | P3(1)c |
| | (0.171 mmol) | p-xylene | | | | | | | |
| | H₃BTB | ethanol | | | | | | | |
| | (0.114 mmol) | | | | | | | | |
| AS16 | FeBr₂ | DMF | 90 | 90.13 | 90 | 7.2595 | 8.7894 | 19.484 | P2(1)c |
| | 0.927 mmol | anhydr. | | | | | | | |
| | H₂(BDC) | | | | | | | | |
| | 0.927 mmol | | | | | | | | |
| AS27-2 | FeBr₂ | DMF | 90 | 90 | 90 | 26.735 | 26.735 | 26.735 | Fm3m |
| | 0.927 mmol | anhydr. | | | | | | | |
| | H₃(BDC) | | | | | | | | |
| | 0.464 mmol | | | | | | | | |
| AS32 | FeCl₃ | DMF | 90 | 90 | 120 | 12.535 | 12.535 | 18.479 | P6(2)c |
| | 1.23 mmol | anhydr. | | | | | | | |
| | H₂(BDC) | ethanol | | | | | | | |
| | 1.23 mmol | | | | | | | | |
| AS54-3 | FeBr₂ | DMF | 90 | 109.98 | 90 | 12.019 | 15.286 | 14.399 | C2 |
| | 0.927 | anhydr. | | | | | | | |
| | BPDC | n-propanol | | | | | | | |
| | 0.927 mmol | | | | | | | | |
| AS61-4 | FeBr₂ | pyridine | 90 | 90 | 120 | 13.017 | 13.017 | 14.896 | P6(2)c |
| | 0.927 mmol | anhydr. | | | | | | | |
| | m-BDC | | | | | | | | |
| | 0.927 mmol | | | | | | | | |
| AS68-7 | FeBr₂ | DMF | 90 | 90 | 90 | 18.3407 | 10.036 | 18.039 | Pca2₁ |
| | 0.927 mmol | anhydr. | | | | | | | |
| | m-BDC | pyridine | | | | | | | |
| | 1.204 mmol | | | | | | | | |
| Zn(ADC) | Zn(NO₃)₂•6H₂O | DMF | 90 | 99.85 | 90 | 16.764 | 9.349 | 9.635 | C2/c |
| | 0.37 mmol | chloro- | | | | | | | |
| | H₂(ADC) | benzene | | | | | | | |
| | 0.36 mmol | | | | | | | | |
| MOF-12 | Zn(NO₃)₂6H₂O | ethanol | 90 | 90 | 90 | 15.745 | 16.907 | 18.167 | Pbca |
| Zn₂ (ATC) | 0.30 mmol | | | | | | | | |
| | H₄(ATC) | | | | | | | | |
| | 0.15 mmol | | | | | | | | |
| MOF-20 | Zn(NO₃)₂•6H₂O | DMF | 90 | 92.13 | 90 | 8.13 | 16.444 | 12.807 | P2(1)/c |
| ZnNDC | 0.37 mmol | chloro- | | | | | | | |
| | H₂NDC | benzene | | | | | | | |
| | 0.36 mmol | | | | | | | | |
| MOF-37 | Zn(NO₃)₂•6H₂O | DEF | 72.38 | 83.16 | 84.33 | 9.952 | 11.576 | 15.556 | P-1 |
| | 0.20 mmol | chloro- | | | | | | | |
| | H₂NDC | benzene | | | | | | | |
| | 0.20 mmol | | | | | | | | |
| Zn(NDC) | Zn(NO₃)₂•6H₂O | DMSO | 68.08 | 75.33 | 88.31 | 8.631 | 10.207 | 13.114 | P-1 |
| (DMSO) | H₂NDC | | | | | | | | |
| Zn(NDC) | Zn(NO₃)₂•6H₂O | | 90 | 99.2 | 90 | 19.289 | 17.628 | 15.052 | C2/c |
| | H₂NDC | | | | | | | | |
| Zn(HPDC) | Zn(NO₃)₂•4H₂O | DMF | 107.9 | 105.06 | 94.4 | 8.326 | 12.085 | 13.767 | P-1 |
| | 0.23 mmol | H₂O | | | | | | | |
| | H₂(HPDC) | | | | | | | | |
| | 0.05 mmol | | | | | | | | |
| Co(HPDC) | Co(NO₃)₂•6H₂O | DMF | 90 | 97.69 | 90 | 29.677 | 9.63 | 7.981 | C2/c |
| | 0.21 mmol | H₂O/ | | | | | | | |
| | H₂ (HPDC) | ethanol | | | | | | | |
| | 0.06 mmol | | | | | | | | |
| Zn₃(PDC) | Zn(NO₃)₂•4H₂O | DMF/ | 79.34 | 80.8 | 85.83 | 8.564 | 14.046 | 26.428 | P-1 |
| 2.5 | 0.17 mmol | ClBz | | | | | | | |
| | H₂(HPDC) | H₂0/TEA | | | | | | | |
| | 0.05 mmol | | | | | | | | |
| Cd₂ | Cd(NO₃)₂•4H₂O | methanol/ | 70.59 | 72.75 | 87.14 | 10.102 | 14.412 | 14.964 | P-1 |
| (TPDC)2 | 0.06 mmol | CHP | | | | | | | |
| | H₂(HPDC) | H₂O | | | | | | | |
| | 0.06 mmol | | | | | | | | |
| Tb(PDC)1.5 | Tb(NO₃)₃•5H₂O | DMF | 109.8 | 103.61 | 100.14 | 9.829 | 12.11 | 14.628 | P-1 |
| | 0.21 mmol | H₂O/ | | | | | | | |
| | H₂(PDC) | ethanol | | | | | | | |
| | 0.034 mmol | | | | | | | | |
| ZnDBP | Zn(NO₃)₂•6H₂O | MeOH | 90 | 93.67 | 90 | 9.254 | 10.762 | 27.93 | P2/n |
| | 0.05 mmol | | | | | | | | |
| | dibenzyl | | | | | | | | |
| | phosphate | | | | | | | | |
| | 0.10 mmol | | | | | | | | |
| Zn₃(BPDC) | ZnBr₂ | DMF | 90 | 102.76 | 90 | 11.49 | 14.79 | 19.18 | P21/n |
| | 0.021 mmol | | | | | | | | |
| | 4,4′BPDC | | | | | | | | |
| | 0.005 mmol | | | | | | | | |
| CdBDC | Cd(NO₃)₂•4H₂O | DMF | 90 | 95.85 | 90 | 11.2 | 11.11 | 16.71 | P21/n |
| | 0.100 mmol | Na₂SiO₃ | | | | | | | |
| | H₂(BDC) | (aq) | | | | | | | |
| | 0.401 mmol | | | | | | | | |
| Cd-mBDC | Cd(NO₃)₂•4H₂O | DMF | 90 | 101.1 | 90 | 13.69 | 18.25 | 14.91 | C2/c |
| | 0.009 mmol | MeNH₂ | | | | | | | |
| | H₂(mBDC) | | | | | | | | |
| | 0.018 mmol | | | | | | | | |
| Zn₄OBNDC | Zn(NO₃)₂•6H₂O | DEF | 90 | 90 | 90 | 22.35 | 26.05 | 59.56 | Fmmm |
| | 0.041 mmol | MeNH₂ | | | | | | | |
| | BNDC | H₂O₂ | | | | | | | |
| Eu(TCA) | Eu(NO₃)₃•6H₂O | DMF | 90 | 90 | 90 | 23.325 | 23.325 | 23.325 | Pm-3n |
| | 0.14 mmol | chloro- | | | | | | | |
| | TCA | benzene | | | | | | | |
| | 0.026 mmol | | | | | | | | |
| Tb(TCA) | Tb(NO₃)₃•6H₂O | DMF | 90 | 90 | 90 | 23.272 | 23.272 | 23.372 | Pm-3n |
| | 0.069 mmol | chloro- | | | | | | | |
| | TCA | benzene | | | | | | | |
| | 0.026 mmol | | | | | | | | |
| Formate | Ce(NO₃)₃•6H₂O | H₂O | 90 | 90 | 120 | 10.668 | 10.667 | 4.107 | R-3m |
| | 0.138 mmol | ethanol | | | | | | | |
| | formic acid | | | | | | | | |
| | 0.43 mmol | | | | | | | | |
| | FeCl₂•4H₂O | DMF | 90 | 90 | 120 | 8.2692 | 8.2692 | 63.566 | R-3c |
| | 5.03 mmol | | | | | | | | |
| | formic acid | | | | | | | | |
| | 86.90 mmol | | | | | | | | |
| | FeCl₂•4H₂O | DEF | 90 | 90 | 90 | 9.9364 | 18.374 | 18.374 | Pbcn |
| | 5.03 mmol | | | | | | | | |
| | formic acid | | | | | | | | |
| | 86.90 mmol | | | | | | | | |
| | FeCl₂•4H₂O | DEF | 90 | 90 | 90 | 8.335 | 8.335 | 13.34 | P-31c |
| | 5.03 mmol | | | | | | | | |
| | formic acid | | | | | | | | |
| | 86.90 mmol | | | | | | | | |
| NO330 | FeCl₂•4H₂O | formamide | 90 | 90 | 90 | 8.7749 | 11.655 | 8.3297 | Pnna |
| | 0.50 mmol | | | | | | | | |
| | formic acid | | | | | | | | |
| | 8.69 mmol | | | | | | | | |
| NO332 | FeCl₂•4H₂O | DIP | 90 | 90 | 90 | 10.0313 | 18.808 | 18.355 | Pbcn |
| | 0.50 mmol | | | | | | | | |
| | formic acid | | | | | | | | |
| | 8.69 mmol | | | | | | | | |
| NO333 | FeCl₂•4H₂O | DBF | 90 | 90 | 90 | 45.2754 | 23.861 | 12.441 | Cmcm |
| | 0.50 mmol | | | | | | | | |
| | formic acid | | | | | | | | |
| | 8.69 mmol | | | | | | | | |
| NO335 | FeCl₂•4H₂O | CHF | 90 | 91.372 | 90 | 11.5964 | 10.187 | 14.945 | P21/n |
| | 0.50 mmol | | | | | | | | |
| | formic acid | | | | | | | | |
| | 8.69 mmol | | | | | | | | |
| NO336 | FeCl₂•4H₂O | MFA | 90 | 90 | 90 | 11.7945 | 48.843 | 8.4136 | Pbcm |
| | 0.50 mmol | | | | | | | | |
| | formic acid | | | | | | | | |
| | 8.69 mmol | | | | | | | | |
| NO13 | Mn(Ac)₂•4H₂O | ethanol | 90 | 90 | 90 | 18.66 | 11.762 | 9.418 | Pbcn |
| | 0.46 mmol | | | | | | | | |
| | benzoic acid | | | | | | | | |
| | 0.92 mmol | | | | | | | | |
| | bipyridine | | | | | | | | |
| | 0.46 mmol | | | | | | | | |
| NO29 | Mn(Ac)₂•4H₂O | DMF | 120 | 90 | 90 | 14.16 | 33.521 | 33.521 | P-1 |
| MOF-0 | 0.46 mmol | | | | | | | | |
| similar | H₃BTC | | | | | | | | |
| | 0.69 mmol | | | | | | | | |
| Mn(hfac)₂ | Mn(Ac)₂•4H₂O | ether | 90 | 95.32 | 90 | 9.572 | 17.162 | 14.041 | C2/c |
| (O₂CC₆H₅) | 0.46 mmol | | | | | | | | |
| | Hfac | | | | | | | | |
| | 0.92 mmol | | | | | | | | |
| | bipyridine | | | | | | | | |
| | 0.46 mmol | | | | | | | | |
| BPR43G2 | Zn(NO₃)₂•6H₂O | DMF | 90 | 91.37 | 90 | 17.96 | 6.38 | 7.19 | C2/c |
| | 0.0288 mmol | CH₃CN | | | | | | | |
| | H₂BDC | | | | | | | | |
| | 0.0072 mmol | | | | | | | | |
| BPR48A2 | Zn(NO₃)₂ 6H₂O | DMSO | 90 | 90 | 90 | 14.5 | 17.04 | 18.02 | Pbca |
| | 0.012 mmol | toluene | | | | | | | |
| | H₂BDC | | | | | | | | |
| | 0.012 mmol | | | | | | | | |
| BPR49B1 | Zn(NO₃)₂ 6H₂O | DMSO | 90 | 91.172 | 90 | 33.181 | 9.824 | 17.884 | C2/c |
| | 0.024 mmol | methanol | | | | | | | |
| | H₂BDC | | | | | | | | |
| | 0.048 mmol | | | | | | | | |
| BPR56E1 | Zn(NO₃)₂ 6H₂O | DMSO | 90 | 90.096 | 90 | 14.5873 | 14.153 | 17.183 | P2(1)/n |
| | 0.012 mmol | n-propanol | | | | | | | |
| | H₂BDC | | | | | | | | |
| | 0.024 mmol | | | | | | | | |
| BPR68D10 | Zn(NO₃)₂ 6H₂O | DMSO | 90 | 95.316 | 90 | 10.0627 | 10.17 | 16.413 | P2(1)/c |
| | 0.0016 mmol | benzene | | | | | | | |
| | H₃BTC | | | | | | | | |
| | 0.0064 mmol | | | | | | | | |
| BPR69B1 | Cd(NO₃)₂ 4H₂O | DMSO | 90 | 98.76 | 90 | 14.16 | 15.72 | 17.66 | Cc |
| | 0.0212 mmol | | | | | | | | |
| | H₂BDC | | | | | | | | |
| | 0.0428 mmol | | | | | | | | |
| BPR73E4 | Cd(NO₃)₂ 4H₂O | DMSO | 90 | 92.324 | 90 | 8.7231 | 7.0568 | 18.438 | P2(1)/n |
| | 0.006 mmol | toluene | | | | | | | |
| | H₂BDC | | | | | | | | |
| | 0.003 mmol | | | | | | | | |
| BPR76D5 | Zn(NO₃)₂6H₂O | DMSO | 90 | 104.17 | 90 | 14.4191 | 6.2599 | 7.0611 | Pc |
| | 0.0009 mmol | | | | | | | | |
| | H₂BzPDC | | | | | | | | |
| | 0.0036 mmol | | | | | | | | |
| BPR80B5 | Cd(NO₃)₂•4H₂O | DMF | 90 | 115.11 | 90 | 28.049 | 9.184 | 17.837 | C2/c |
| | 0.018 mmol | | | | | | | | |
| | H₂BDC | | | | | | | | |
| | 0.036 mmol | | | | | | | | |
| BPR80H5 | Cd(NO₃)₂ 4H₂O | DMF | 90 | 119.06 | 90 | 11.4746 | 6.2151 | 17.268 | P2/c |
| | 0.027 mmol | | | | | | | | |
| | H₂BDC | | | | | | | | |
| | 0.027 mmol | | | | | | | | |
| BPR82C6 | Cd(NO₃)₂ 4H₂O | DMF | 90 | 90 | 90 | 9.7721 | 21.142 | 27.77 | Fdd2 |
| | 0.0068 mmol | | | | | | | | |
| | H₂BDC | | | | | | | | |
| | 0.202 mmol | | | | | | | | |
| BPR86C3 | Co(NO₃)₂ 6H₂O | DMF | 90 | 90 | 90 | 18.3449 | 10.031 | 17.983 | Pca2(1) |
| | 0.0025 mmol | | | | | | | | |
| | H₂BDC | | | | | | | | |
| | 0.075 mmol | | | | | | | | |
| BPR86H6 | Cd(NO₃)₂•6H₂O | DMF | 80.98 | 89.69 | 83.412 | 9.8752 | 10.263 | 15.362 | P-1 |
| | 0.010 mmol | | | | | | | | |
| | H₂BDC | | | | | | | | |
| | 0.010 mmol | | | | | | | | |
| | Co(NO₃)₂ 6H₂O | NMP | 106.3 | 107.63 | 107.2 | 7.5308 | 10.942 | 11.025 | P1 |
| BPR95A2 | Zn(NO₃)₂ 6H₂O | NMP | 90 | 102.9 | 90 | 7.4502 | 13.767 | 12.713 | P2(1)/c |
| | 0.012 mmol | | | | | | | | |
| | H₂BDC | | | | | | | | |
| | 0.012 mmol | | | | | | | | |
| CuC₆F₄O₄ | Cu(NO₃)₂•2.5H₂O | DMF | 90 | 98.834 | 90 | 10.9675 | 24.43 | 22.553 | P2(1)/n |
| | 0.370 mmol | chloro- | | | | | | | |
| | H₂BDC(OH)₂ | benzene | | | | | | | |
| | 0.37 mmol | | | | | | | | |
| Fe formic | FeCl₂•4H₂O | DMF | 90 | 91.543 | 90 | 11.495 | 9.963 | 14.48 | P2(1)/n |
| | 0.370 mmol | | | | | | | | |
| | formic acid | | | | | | | | |
| | 0.37 mmol | | | | | | | | |
| Mg formic | Mg(NO₃)₂•6H₂O | DMF | 90 | 91.359 | 90 | 11.383 | 9.932 | 14.656 | P2(1)/n |
| | 0.370 mmol | | | | | | | | |
| | formic acid | | | | | | | | |
| | 0.37 mmol | | | | | | | | |
| MgC₆H₄O₆ | Mg(NO₃)₂•6H₂O | DMF | 90 | 96.624 | 90 | 17.245 | 9.943 | 9.273 | C2/c |
| | 0.370 mmol | | | | | | | | |
| | H₂BDC(OH)₂ | | | | | | | | |
| | 0.37 mmol | | | | | | | | |
| Zn | ZnCl₂ | DMF | 90 | 94.714 | 90 | 7.3386 | 16.834 | 12.52 | P2(1)/n |
| C₂H₄BDC | 0.44 mmol | | | | | | | | |
| MOF-38 | CBBDC | | | | | | | | |
| | 0.261 mmol | | | | | | | | |
| MOF-49 | ZnCl₂ | DMF | 90 | 93.459 | 90 | 13.509 | 11.984 | 27.039 | P2/c |
| | 0.44 mmol | CH₃CN | | | | | | | |
| | m-BDC | | | | | | | | |
| | 0.261 mmol | | | | | | | | |
| MOF-26 | Cu(NO₃)₂•5H₂O | DMF | 90 | 95.607 | 90 | 20.8797 | 16.017 | 26.176 | P2(1)/n |
| | 0.084 mmol | | | | | | | | |
| | DCPE | | | | | | | | |
| | 0.085 mmol | | | | | | | | |
| MOF-112 | Cu(NO₃)₂•2.5H₂O | DMF | 90 | 107.49 | 90 | 29.3241 | 21.297 | 18.069 | C2/c |
| | 0.084 mmol | ethanol | | | | | | | |
| | o-Br-m-BDC | | | | | | | | |
| | 0.085 mmol | | | | | | | | |
| MOF-109 | Cu(NO₃)₂•2.5H₂O | DMF | 90 | 111.98 | 90 | 23.8801 | 16.834 | 18.389 | P2(1)/c |
| | 0.084 mmol | | | | | | | | |
| | KDB | | | | | | | | |
| | 0.085 mmol | | | | | | | | |
| MOF-111 | Cu(NO₃)₂•2.5H₂O | DMF | 90 | 102.16 | 90 | 10.6767 | 18.781 | 21.052 | C2/c |
| | 0.084 mmol | ethanol | | | | | | | |
| | o-BrBDC | | | | | | | | |
| | 0.085 mmol | | | | | | | | |
| MOF-110 | Cu(NO₃)₂•2.5H₂O | DMF | 90 | 90 | 120 | 20.0652 | 20.065 | 20.747 | R-3/m |
| | 0.084 mmol | | | | | | | | |
| | thiophene- | | | | | | | | |
| | dicarboxylic acid | | | | | | | | |
| | 0.085 mmol | | | | | | | | |
| MOF-107 | Cu(NO₃)₂•2.5H₂O | DEF | 104.8 | 97.075 | 95.206 | 11.032 | 18.067 | 18.452 | P-1 |
| | 0.084 mmol | | | | | | | | |
| | thiophene- | | | | | | | | |
| | dicarboxylic acid | | | | | | | | |
| | 0.085 mmol | | | | | | | | |
| MOF-108 | Cu(NO₃)₂•2.5H₂O | DBF/ | 90 | 113.63 | 90 | 15.4747 | 14.514 | 14.032 | C2/c |
| | 0.084 mmol | methanol | | | | | | | |
| | thiophene- | | | | | | | | |
| | dicarboxylic acid | | | | | | | | |
| | 0.085 mmol | | | | | | | | |
| MOF-102 | Cu(NO₃)₂•2.5H₂O | DMF | 91.63 | 106.24 | 112.01 | 9.3845 | 10.794 | 10.831 | P-1 |
| | 0.084 mmol | | | | | | | | |
| | H₂(BDCCl₂) | | | | | | | | |
| | 0.085 mmol | | | | | | | | |
| Clbdc1 | Cu(NO₃)₂•2.5H₂O | DEF | 90 | 105.56 | 90 | 14.911 | 15.622 | 18.413 | P-1 |
| | 0.084 mmol | | | | | | | | |
| | H₂(BDCCl₂) | | | | | | | | |
| | 0.085 mmol | | | | | | | | |
| Cu(NMOP) | Cu(NO₃)₂•2.5H₂O | DMF | 90 | 102.37 | 90 | 14.9238 | 18.727 | 15.529 | P2(1)/m |
| | 0.084 mmol | | | | | | | | |
| | NBDC | | | | | | | | |
| | 0.085 mmol | | | | | | | | |
| Tb(BTC) | Tb(NO₃)₃•5H₂O | DMF | 90 | 106.02 | 90 | 18.6986 | 11.368 | 19.721 | |
| | 0.033 mmol | | | | | | | | |
| | H₃BTC | | | | | | | | |
| | 0.033 mmol | | | | | | | | |
| Zn₃(BTC)₂ | ZnCl₂ | DMF | 90 | 90 | 90 | 26.572 | 26.572 | 26.572 | Fm-3m |
| Honk | 0.033 mmol | ethanol | | | | | | | |
| | H₃BTC | | | | | | | | |
| | 0.033 mmol | | | | | | | | |
| Zn₄O(NDC) | Zn(NO₃)₂•4H₂O | DMF | 90 | 90 | 90 | 41.5594 | 18.818 | 17.574 | aba2 |
| | 0.066 mmol | ethanol | | | | | | | |
| | 14NDC | | | | | | | | |
| | 0.066 mmol | | | | | | | | |
| CdTDC | Cd(NO₃)₂•4H₂O | DMF | 90 | 90 | 90 | 12.173 | 10.485 | 7.33 | Pmma |
| | 0.014 mmol | H₂O | | | | | | | |
| | thiophene | | | | | | | | |
| | 0.040 mmol | | | | | | | | |
| | DABCO | | | | | | | | |
| | 0.020 mmol | | | | | | | | |
| IRMOF-2 | Zn(NO₃)₂•4H₂O | DEF | 90 | 90 | 90 | 25.772 | 25.772 | 25.772 | Fm-3m |
| | 0.160 mmol | | | | | | | | |
| | o-Br-BDC | | | | | | | | |
| | 0.60 mmol | | | | | | | | |
| IRMOF-3 | Zn(NO₃)₂•4H₂O | DEF | 90 | 90 | 90 | 25.747 | 25.747 | 25.747 | Fm-3m |
| | 0.20 mmol | ethanol | | | | | | | |
| | H₂N-BDC | | | | | | | | |
| | 0.60 mmol | | | | | | | | |
| IRMOF-4 | Zn(NO₃)₂•4H₂O | DEF | 90 | 90 | 90 | 25.849 | 25.849 | 25.849 | Fm-3m |
| | 0.11 mmol | | | | | | | | |
| | [C₃H₇O]₂-BDC | | | | | | | | |
| | 0.48 mmol | | | | | | | | |
| IRMOF-5 | Zn(NO₃)₂•4H₂O | DEF | 90 | 90 | 90 | 12.882 | 12.882 | 12.882 | Pm-3m |
| | 0.13 mmol | | | | | | | | |
| | [C₅H₁₁O]₂-BDC | | | | | | | | |
| | 0.50 mmol | | | | | | | | |
| IRMOF-6 | Zn(NO₃)₂•4H₂O | DBF | 90 | 90 | 90 | 25.842 | 25.842 | 25.842 | Fm-3m |
| | 0.20 mmol | | | | | | | | |
| | [C₂H₄]-BDC | | | | | | | | |
| | 0.60 mmol | | | | | | | | |
| IRMOF-7 | Zn(NO₃)₂•4H₂O | DEF | 90 | 90 | 90 | 12.914 | 12.914 | 12.914 | Pm-3m |
| | 0.07 mmol | | | | | | | | |
| | 1,4NDC | | | | | | | | |
| | 0.20 mmol | | | | | | | | |
| IRMOF-8 | Zn(NO₃)₂•4H₂O | DEF | 90 | 90 | 90 | 30.092 | 30.092 | 30.092 | Fm-3m |
| | 0.55 mmol | | | | | | | | |
| | 2,6NDC | | | | | | | | |
| | 0.42 mmol | | | | | | | | |
| IRMOF-9 | Zn(NO₃)₂•4H₂O | DEF | 90 | 90 | 90 | 17.147 | 23.322 | 25.255 | Pnnm |
| | 0.05 mmol | | | | | | | | |
| | BPDC | | | | | | | | |
| | 0.42 mmol | | | | | | | | |
| IRMOF-10 | Zn(NO₃)₂•4H₂O | DEF | 90 | 90 | 90 | 34.281 | 34.281 | 34.281 | Fm-3m |
| | 0.02 mmol | | | | | | | | |
| | BPDC | | | | | | | | |
| | 0.012 mmol | | | | | | | | |
| IRMOF-11 | Zn(NO₃)₂•4H₂O | DEF | 90 | 90 | 90 | 24.822 | 24.822 | 56.734 | R-3m |
| | 0.05 mmol | | | | | | | | |
| | HPDC | | | | | | | | |
| | 0.20 mmol | | | | | | | | |
| IRMOF-12 | Zn(NO₃)₂•4H₂O | DEF | 90 | 90 | 90 | 34.281 | 34.281 | 34.281 | Fm-3m |
| | 0.017 mmol | | | | | | | | |
| | HPDC | | | | | | | | |
| | 0.12 mmol | | | | | | | | |
| IRMOF-13 | Zn(NO₃)₂•4H₂O | DEF | 90 | 90 | 90 | 24.822 | 24.822 | 56.734 | R-3m |
| | 0.048 mmol | | | | | | | | |
| | PDC | | | | | | | | |
| | 0.31 mmol | | | | | | | | |
| IRMOF-14 | Zn(NO₃)₂•4H₂O | DEF | 90 | 90 | 90 | 34.381 | 34.381 | 34.381 | Fm-3m |
| | 0.17 mmol | | | | | | | | |
| | PDC | | | | | | | | |
| | 0.12 mmol | | | | | | | | |
| IRMOF-15 | Zn(NO₃)₂•4H₂O | DEF | 90 | 90 | 90 | 21.459 | 21.459 | 21.459 | Im-3m |
| | 0.063 mmol | | | | | | | | |
| | TPDC | | | | | | | | |
| | 0.025 mmol | | | | | | | | |
| IRMOF-16 | Zn(NO₃)₂•4H₂O | DEF | 90 | 90 | 90 | 21.49 | 21.49 | 21.49 | Pm-3m |
| | 0.0126 mmol | NMP | | | | | | | |
| | TPDC | | | | | | | | |
| | 0.05 mmol | | | | | | | | |

ADC Acetylenedicarboxylic acid
NDC Naphthalenedicarboxylic acid
BDC Benzenedicarboxylic acid
ATC Adamantanetetracarboxylic acid
BTC Benzenetricarboxylic acid
BTB Benzenetribenzoic acid
MTB Methanetetrabenzoic acid
ATB Adamantanetetrabenzoic acid
ADB Adamantanedibenzoic acid

Further metal organic frameworks are MOF-2 to 4, MOF-9, MOF-31 to 36, MOF-39, MOF-69 to 80, MOF103 to 106, MOF-122, MOF-125, MOF-150, MOF-177, MOF-178, MOF-235, MOF-236, MOF-500, MOF-501, MOF-502, MOF-505, IRMOF-1, IRMOF-61, IRMOP-13, IRMOP-51, MIL-17, MIL-45, MIL-47, MIL-53, MIL-59, MIL-60, MIL-61, MIL-63, MIL-68, MIL-79, MIL-80, MIL-83, MIL-85, CPL-1 to 2, SZL-1, which are described in the literature.

Particularly preferred metal organic frameworks are MIL-53, Zn-tBu-isophthalic acid, Al-BDC, MOF-5, IRMOF-8, Cu-BTC, Al-NDC, Al-aminoBDC, Cu-BDC-TEDA, Zn-BDC-TEDA, Al-BTC, Al-NDC, Mg-NDC, Al-fumarate, Zn-2-methylimidazolate, Zn-2-aminoimidazolate, Cu-biphenyldicarboxylate-TEDA, MOF-177, MOF-74. Greater preference is given to Al-BDC and Al-BTC.

Apart from the conventional method of preparing MOFs, as is described, for example, in U.S. Pat. No. 5,648,508, these can also be prepared by means of an electrochemical route. In this regard, reference may be made to DE-A 103 55 087 and WO-A 2005/049892. The metal organic frameworks prepared in this way have particularly good properties in respect of the adsorption and desorption of chemical substances, in particular gases.

Regardless of the method of preparation, the metal organic framework is obtained in pulverulent or crystalline form. This can be used as such as sorbent, either alone or together with other sorbents or further materials, in the mixture of the invention. It is preferably used as a loose material, in particular in a fixed bed. The metal organic framework can also be converted into a shaped body. Preferred processes here are extrusion or tableting. In the production of shaped bodies, further materials such as binders, lubricants or other additives can be added to the metal organic framework. It is likewise conceivable for mixtures of framework and other adsorbents, for example activated carbon, to be produced as shaped bodies or be converted separately into shaped bodies which are then used as mixtures of shaped bodies.

The possible geometries of these shaped bodies are essentially not subject to any restrictions. For example, possible shapes are, inter alia, pellets such as disk-shaped pellets, pills, spheres, granules, extrudates such as rods, honeycombs, grids or hollow bodies.

Component B is preferably present as shaped bodies. Preferred embodiments are tablets and rod-shaped extrudates. The shaped bodies preferably have at least one dimension in the range from 0.2 mm to 30 mm, more preferably from 0.5 mm to 5 mm, in particular from 1 mm to 3 mm.

The average density of the mixture is typically in the range from 0.2 to 0.7 kg/l.

To produce these shaped bodies, it is in principle possible to employ all suitable methods. In particular, the following processes are preferred:
Kneading of the framework either alone or together with at least one binder and/or at least one pasting agent and/or at least one template compound to give a mixture; shaping of the resulting mixture by means of at least one suitable method such as extrusion; optionally washing and/or drying and/or calcination of the extrudate; optionally finishing treatment.
Application of the framework to at least one optionally porous support material. The material obtained can then be processed further by the above-described method to give a shaped body.
Application of the framework to at least one optionally porous substrate.

Kneading and shaping can be carried out by any suitable method, for example as described in Ullmanns Enzyklopädie der Technischen Chemie, 4th edition, volume 2, p. 313 ff. (1972), whose relevant contents are fully incorporated by reference into the present patent application.

For example, the kneading and/or shaping can preferably be carried out by means of a piston press, roller press in the presence or absence of at least one binder, compounding, pelletization, tableting, extrusion, coextrusion, foaming, spinning, coating, granulation, preferably spray granulation, spraying, spray drying or a combination of two or more of these methods.

Very particular preference is given to producing pellets and/or tablets.

The kneading and/or shaping can be carried out at elevated temperatures, for example in the range from room temperature to 300° C., and/or under superatmospheric pressure, for example in the range from atmospheric pressure to a few hundred bar, and/or in a protective gas atmosphere, for example in the presence of at least one noble gas, nitrogen or a mixture of two or more thereof.

The kneading and/or shaping is, in a further embodiment, carried out with addition of at least one binder, with the binder used basically being able to be any chemical compound which ensures the desired viscosity for the kneading and/or shaping of the composition to be kneaded and/or shaped. Accordingly, binders can, for the purposes of the present invention, be either viscosity-increasing or viscosity-reducing compounds.

Preferred binders are, for example, inter alia aluminum oxide or binders comprising aluminum oxide, as are described, for example, in WO 94/29408, silicon dioxide as described, for example, in EP 0 592 050 A1, mixtures of silicon dioxide and aluminum oxide, as are described, for example, in WO 94/13584, clay minerals as described, for example, in JP 03-037156 A, for example montmorillonite, kaolin, bentonite, hallosite, dickite, nacrite and anauxite, alkoxysilanes as described, for example, in EP 0 102 544 B1, for example tetraalkoxysilanes such as tetramethoxysilane, tetraethoxysilane, tetrapropoxysilane, tetrabutoxysilane, or, for example, trialkoxysilanes such as trimethoxysilane, triethoxysilane, tripropoxysilane, tributoxysilane, alkoxytitanates, for example tetraalkoxytitanates such as tetramethoxytitanate, tetraethoxytitanate, tetrapropoxytitanate, tetrabutoxytitanate, or, for example, trialkoxytitanates such as trimethoxytitanate, triethoxytitanate, tripropoxytitanate, tributoxytitanate, alkoxyzirconates, for example tetraalkoxyzirconates such as tetramethoxyzirconate, tetraethoxyzirconate, tetrapropoxyzirconate, tetrabutoxyzirconate, or, for example, trialkoxyzirconates such as trimethoxyzirconate, triethoxyzirconate, tripropoxyzirconate, tributoxyzirconate, silica sols, amphiphilic substances and/or graphites. Particular preference is given to graphite.

As viscosity-increasing compound, it is, for example, also possible to use, if appropriate in addition to the abovementioned compounds, an organic compound and/or a hydrophilic polymer such as cellulose or a cellulose derivative such as methylcellulose and/or a polyacrylate and/or a polymethacrylate and/or a polyvinyl alcohol and/or a polyvinylpyrrolidone and/or a polyisobutene and/or a polytetrahydrofuran.

As pasting agent, it is possible to use, inter alia, preferably water or at least one alcohol such as a monoalcohol having from 1 to 4 carbon atoms, for example methanol, ethanol, n-propanol, isopropanol, 1-butanol, 2-butanol, 2-methyl-1-propanol or 2-methyl-2-propanol or a mixture of water and at least one of the alcohols mentioned or a polyhydric alcohol such as a glycol, preferably a water-miscible polyhydric alcohol, either alone or as a mixture with water and/or at least one of the monohydric alcohols mentioned.

Further additives which can be used for kneading and/or shaping are, inter alia, amines or amine derivatives such as tetraalkylammonium compounds or amino alcohols and carbonate-comprising compounds such as calcium carbonate. Such further additives are described, for instance, in EP 0 389 041 A1, EP 0 200 260 A1 or WO 95/19222.

The order of the additives such as template compound, binder, pasting agent, viscosity-increasing substance during shaping and kneading is in principle not critical.

In a further, preferred embodiment, the shaped body obtained by kneading and/or shaping is subjected to at least one drying step which is generally carried out at a temperature in the range from 25 to 300° C., preferably in the range from 50 to 300° C. and particularly preferably in the range from 100 to 300° C. It is likewise possible to carry out drying under reduced pressure or under a protective gas atmosphere or by spray drying.

In a particularly preferred embodiment, at least one of the compounds added as additives is at least partly removed from the shaped body during this drying process.

The present invention further provides for the use of a mixture according to the invention for the uptake of at least one substance for the purposes of its storage, separation, controlled release, chemical reaction or as support.

The at least one substance is preferably a gas or gas mixture.

Processes for storage by means of metal organic frameworks in general are described in WO-A 2005/003622, WO-A 2003/064030, WO-A 2005/049484, WO-A 2006/089908 and DE-A 10 2005 012 087. The processes described there can also be used for the metal organic framework according to the invention.

Processes for separation or purification by means of metal organic frameworks in general are described in EP-A 1 674 555, DE-A 10 2005 000938 and in the German patent application number DE-A 10 2005 022 844. The processes described there can also be used for the metal organic framework according to the invention.

If the porous metal organic framework according to the invention is used for storage, this is preferably carried out in a temperature range from −200° C. to +80° C. Greater preference is given to a temperature range from −40° C. to +80° C.

For the purposes of the present invention, the terms “gas” and “liquid” are used for the purposes of simplicity, but gas mixtures and liquid mixtures or liquid solutions are likewise included under the term “gas” or “liquid”, respectively.

Preferred gases are hydrogen, natural gas, town gas, hydrocarbons, in particular methane, ethane, ethene, acetylene, propane, n-butane and i-butane, carbon monoxide, carbon dioxide, nitrogen oxides, oxygen, sulfur oxides, halogens, halogenated hydrocarbons, NF₃, SF₆, ammonia, boranes, phosphanes, hydrogen sulfide, amines, formaldehyde, noble gases, in particular helium, neon, argon, krypton and xenon.

The gas is particularly preferably carbon dioxide which is separated off from a gas mixture comprising carbon dioxide. The gas mixture preferably comprises at least H₂, CH₄ or carbon monoxide in addition to carbon dioxide. In particular, the gas mixture comprises carbon monoxide together with carbon dioxide. Very particular preference is given to mixtures which comprise at least 10 and not more than 45% by volume of carbon dioxide and at least 30 and not more than 90% by volume of carbon monoxide.

A preferred embodiment is pressure swing adsorption with a plurality of parallel absorber reactors, with the adsorbent bed consisting entirely or partly of the material according to the invention. The adsorption phase for the CO₂/CO separation preferably takes place at a CO₂ partial pressure of from 0.6 to 3 bar and a temperature of at least 20° C. but not more than 70° C. To desorb the adsorbed carbon dioxide, the total pressure in the respective adsorber reactor is usually decreased to values in the range from 100 mbar to 1 bar.

Preference is also given to the use of the framework according to the invention for storage of a gas at a minimum pressure of 100 bar (absolute). The minimum pressure is more preferably 200 bar (absolute), in particular 300 bar (absolute). Here, the gas is particularly preferably hydrogen or methane.

However, the at least one substance can also be a liquid. Examples of such a liquid are disinfectants, inorganic or organic solvents, fuels, in particular gasoline or diesel, hydraulic fluid, radiator fluid, brake fluid or an oil, in particular machine oil. The liquid can also be halogenated aliphatic or aromatic, cyclic or acyclic hydrocarbons or mixtures thereof. In particular, the liquid can be acetone, acetonitrile, aniline, anisole, benzene, benzonitrile, bromobenzene, butanol, tert-butanol, quinoline, chlorobenzene, chloroform, cyclohexane, diethylene glycol, diethyl ether, dimethylacetamide, dimethylformamide, dimethyl sulfoxide, dioxane, glacial acetic acid, acetic anhydride, ethyl acetate, ethanol, ethylene carbonate, ethylene dichloride, ethylene glycol, ethylene glycol dimethyl ether, formamide, hexane, isopropanol, methanol, methoxypropanol, 3-methyl-1-butanol, methylene chloride, methyl ethyl ketone, N-methylformamide, N-methylpyrrolidone, nitrobenzene, nitromethane, piperidine, propanol, propylene carbonate, pyridine, carbon disulfide, sulfolane, tetrachloroethene, carbon tetrachloride, tetrahydrofuran, toluene, 1,1,1-trichloroethane, trichloroethylene, triethylamine, triethylene glycol, triglyme, water or mixtures thereof.

Furthermore, the at least one substance can be an odorous substance.

The odorous substance is preferably a volatile organic or inorganic compound which comprises at least one of the elements nitrogen, phosphorus, oxygen, sulfur, fluorine, chlorine, bromine or iodine or is an unsaturated or aromatic hydrocarbon or a saturated or unsaturated aldehyde or a ketone. More preferred elements are nitrogen, oxygen, phosphorus, sulfur, chlorine, bromine; and particular preference is given to nitrogen, oxygen, phosphorus and sulfur.

In particular, the odorous substance is ammonia, hydrogen sulfide, sulfur oxides nitrogen oxides, ozone, cyclic or acyclic amines, thiols, thioethers and aldehydes, ketones, esters, ethers, acids or alcohols. Particular preference is given to ammonia, hydrogen sulfide, organic acids (preferably acetic acid, propionic acid, butyric acid, isobutyric acid, valeric acid, isovaleric acid, caproic acid, heptanoic acid, lauric acid, pelargonic acid) and also cyclic or acyclic hydrocarbons which comprise nitrogen or sulfur and saturated or unsaturated aldehydes such as hexanal, heptanal, octanal, nonanal, decanal, octenal or nonenal and in particular volatile aldehydes such as butyraldehyde, propionaldehyde, acetaldehyde and formaldehyde and also fuels such as gasoline, diesel (constituents).

The odorous substances can also be fragrances which are used, for example, for producing perfumes. Examples of fragrances or oils which can release such fragrances are: essential oils, basil oil, geranium oil, mint oil, cananga oil, cardamom oil, lavender oil, peppermint oil, nutmeg oil, chamomile oil, eucalyptus oil, rosemary oil, lemon oil, lime oil, orange oil, bergamot oil, muscatel sage oil, coriander oil, cypress oil, 1,1-dimethoxy-2-phenylethane, 2,4-dimethyl-4-phenyltetrahydrofuran, dimethyltetra-hydrobenzaldehyde, 2,6-dimethyl-7-octen-2-ol, 1,2-diethoxy-3,7-dimethyl-2,6-octadiene, phenylacetaldehyde, rose oxide, ethyl 2-methylpentanoate, 1-(2,6,6-trimethyl-1,3-cyclohexadien-1-yl)-2-buten-1-one, ethyl vanillin, 2,6-dimethyl-2-octenol, 3,7-dimethyl-2-octenol, tert-butylcyclohexyl acetate, anisyl acetate, allyl cyclohexyloxyacetate, ethyllinalool, Eugenol, coumarin, ethyl acetoacetate, 4-phenyl-2,4,6-trimethyl-1,3-dioxane, 4-methylene-3,5,6,6-tetramethyl-2-heptanone, ethyl tetrahydrosafranate, geranyl nitrile, cis-3-hexen-1-ol, cis-3-hexenyl acetate, cis-3-hexenyl methyl carbonate, 2,6-dimethyl-5-hepten-1-al, 4-(tricyclo[5.2.1.0]decylidene)-8-butanal, 5-(2,2,3-trimethyl-3-cyclopentenyl)-3-methylpentan-2-ol, p-tert-butyl-alpha-methylhydrocinnamaldehyde, ethyl[5.2.1.0]tricyclodecanecarboxylate, geraniol, citronellal, citral, linalool, linalyl acetate, ionone, phenylethanol or mixtures thereof.

For the purposes of the present invention, a volatile odorous substance preferably has a boiling point or boiling range below 300° C. The odorous substance is more preferably a readily volatile compound or mixture. The odorous substance particularly preferably has a boiling point or boiling range below 250° C., more preferably below 230° C., particularly preferably below 200° C.

Preference is likewise given to odorous substances which have a high volatility. The vapor pressure can be employed as a measure of the volatility. For the purposes of the present invention, a volatile odorous substance preferably has a vapor pressure of more than 0.001 kPa (20° C.). The odorous substance is more preferably a readily volatile compound or mixture. The odorous substance particularly preferably has a vapor pressure of more than 0.01 kPa (20° C.), more preferably a vapor pressure of more than 0.05 kPa (20° C.). Particular preference is given to the odorous substance having a vapor pressure of more than 0.1 kPa (20° C.).

Examples in which a chemical reaction can take place in the presence of the metal organic framework according to the invention are provided by the alkoxylation of monools and polyols. The procedure for carrying out such alkoxylations is described in WO-A 03/035717 and WO-A 2005/03069. The porous metal organic framework according to the invention can likewise be used for epoxidation and the preparation of polyalkylene carbonates and hydrogen peroxide. Such reactions are described in WO-A 03/101975, WO-A 2004/037895 and US-A 2004/081611.

Particular preference is given to catalytic reactions.

In addition, the metal organic framework according to the invention can serve as support, in particular as support for a catalyst.

The present invention further provides a process for separating a substance from a mixture of substances, which comprises the steps
(a) contacting the substance with a mixture according to the invention so that it is at least partly taken up by adsorption at a first pressure,
(b) at least partial release of the substance by desorption at a second pressure which is lower than the first pressure and
(c) if appropriate, repetition of steps (a) and (b).

The process of the invention for separating a substance from a mixture of substances is preferably carried out by pressure swing adsorption (PSA). Further preference is given to vacuum pressure swing adsorption.

Furthermore, it is preferred, for the purposes of the present invention, that the repetition of the adsorption in step (a) is carried out in a time of less than 60 minutes. Here, it is advantageous for the first pressure to be at least 1.2 bar (absolute). The second pressure is accordingly not more than 1.1 bar (absolute).

The time for the repetition is preferably less than 20 minutes, more preferably less than 10 minutes. The first pressure is more preferably greater than 2 bar (absolute) but less than 10 bar. The desorption is more preferably carried out at a pressure of less than 500 mbar, in particular less than 300 mbar (absolute).

For the purposes of the present invention, particular preference is given to the substance to be separated off comprising carbon dioxide. In addition, the mixture of substances can comprise at least one gas selected from the group consisting of methane, ethane, propane, n-butane, 2-methylbutane, carbon monoxide and hydrogen.

### EXAMPLES

In the following, Al-BDC is used as metal organic framework component B (“Al-MOF”). Its preparation is described in example 1 of WO-A 2007/023134

As latent heat component A, use is made of a latent heat store analogous to example 8 of DE-A 2005/002 411. Here, an experimental extruder setup (closely intermeshing corotating twin-screw extruder) having a cross-shaped discharge die (4×3 mm profile die) is used for producing a pelletized material.

### Materials:

A) Spray-dried polymethyl methacrylate (PMMA) microcapsule powder as described in DE-A 197 49 731 having an n-eicosane core (melting point about 35° C.) and comprising 87% by weight of core, 10% by weight of crosslinked PMMA wall and 3% of polyvinyl alcohol as dispersant. Mean particle size of the capsules: 3-5 microns.

B) 55% strength by weight aqueous polymer dispersion of a polymers of 88% by weight of styrene, 10% by weight of acrylonitrile and 2% by weight of acrylic acid; number average molecular weight Mn: 8000, volume average molecular weight Mw: 45 000, glass transition temperature Tg: 105° C.

The two materials are fed to the extruder at the following rates: material A (heat storage capsules) 36 kg/h, material B (polymer dispersion diluted to a solids content of 25%) 6 kg/h. The die head temperature of the extruder is 80° C. At this temperature, the material is discharged homogeneously and uniformly from the die and pellets having a length of 2-3 mm and a total diameter of 3 mm are obtained by water-free dry die face cutting. The edges of the pellets are rounded. The theoretical binder content of the pelletized material is 4.0% by weight. The pelletized material is subsequently dried in a stream of hot air and then heat treated at 110° C. for 1 h.

The measured mean particle diameter of the heat-treated cross-shaped pellets was 2.6 mm (measurement method in accordance with ASTM D-2862).

### Example 1

A mixture of 25 ml (12.34 g) of Al-MOF pellets (1.5×1.5 mm) and 25 ml (9.88 g) of latent heat store are introduced into a 50 ml steel pressure vessel provided with an integrated thermocouple. The pressure vessel is then closed. A CO₂ pressure of 20 bar is subsequently built up over a period of 10 seconds and the pressure vessel is left for 3 minutes. The vessel is then depressurized to ambient pressure and again left for 3 minutes. After 10 repetitions, the system is evacuated completely.

### Comparative Example 1

A mixture of 25 ml (12.34 g) of Al-MOF pellets (1.5×1.5 mm) and 25 ml of 6 mm glass spheres are introduced into a 50 ml steel pressure vessel provided with an integrated thermocouple. The pressure vessel is then closed. A CO₂ pressure of 20 bar is subsequently built up over a period of 10 seconds and the pressure vessel is left for 3 minutes. The vessel is then depressurized to ambient pressure and again left for 3 minutes. After 10 repetitions, the system is evacuated completely.

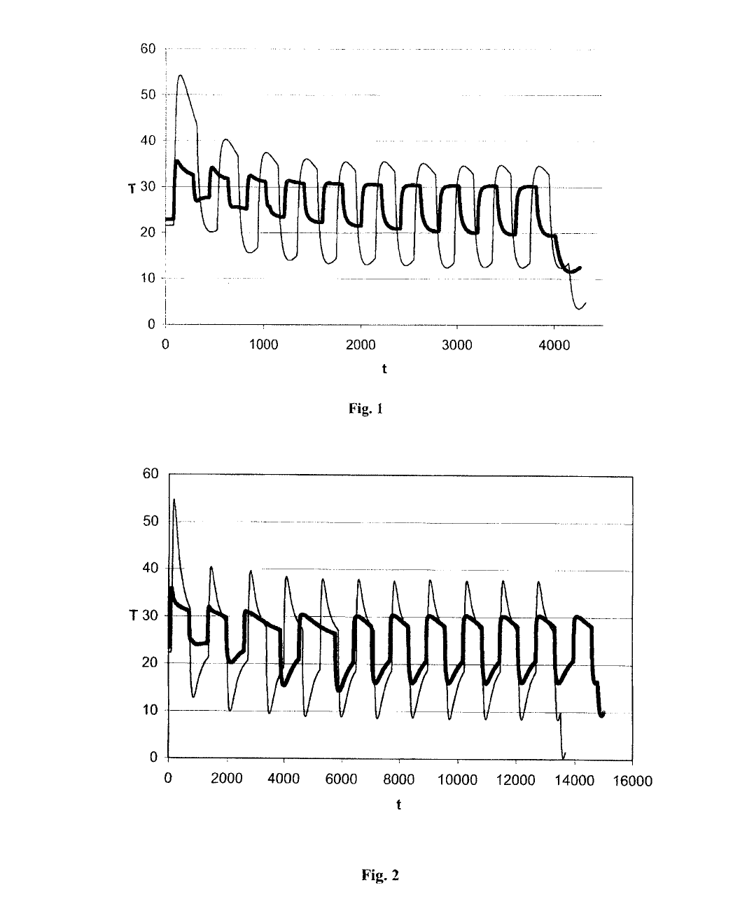

FIG. 1 shows the temperature curves for example 1 and comparative example 1, with the temperature T being shown in ° C. as a function of the time t in seconds. The bold curve corresponds to example 1 and the thin curve corresponds to comparative example 1.

As can be seen from the curves, the temperature fluctuation can be reduced by use of the mixture of the invention.

### Example 2

A mixture of 25 ml (12.34 g) of Al-MOF pellets (1.5×1.5 mm) and 25 ml (9.88 g) of latent heat store are introduced into a 50 ml steel pressure vessel provided with an integrated thermocouple. The pressure vessel is then closed. A CO₂ pressure of 20 bar is subsequently built up over a period of 10 seconds and the pressure vessel is left for 10 minutes. The vessel is then depressurized to ambient pressure and again left for 10 minutes. After 10 repetitions, the system is evacuated completely.

### Comparative Example 2

A mixture of 25 ml (12.34 g) of Al-MOF pellets (1.5×1.5 mm) and 25 ml of 6 mm glass spheres are introduced into a 50 ml steel pressure vessel provided with an integrated thermocouple. The pressure vessel is then closed. A CO₂ pressure of 20 bar is subsequently built up over a period of 10 seconds and the pressure vessel is left for 10 minutes. The vessel is then depressurized to ambient pressure and again left for 10 minutes. After 10 repetitions, the system is evacuated completely.

FIG. 2 shows the temperature curves for example 2 and comparative example 2, with the temperature T being shown in ° C. as a function of the time t in seconds. The bold curve corresponds to example 2 and the thin curve corresponds to comparative example 2.

As can be seen from the curves, the temperature fluctuation can be reduced by use of the mixture of the invention.

1. A mixture comprising, based on the total weight of the mixture,
a) from 2 to 60% by weight of a latent heat storage component A and
b) from 40 to 98% by weight of a framework component B,
wherein the component A comprises at least one microencapsulated latent heat storage material and the component B comprises at least one porous metal organic framework comprising at least one bidentate organic compound coordinated to at least one metal ion.

2. The mixture according to claim 1, wherein the at least one microencapsulated latent heat storage material is an organic lipophilic substance.

3. The mixture according to claim 1, wherein the microencapsulation comprises a homopolymer or copolymer comprising methyl methacrylate.

4. The mixture according to claim 1, wherein the at least one microencapsulated latent heat storage material has a melting point in the range from −20° C. to 120° C.

5. The mixture according to claim 1, wherein the at least one metal ion is an ion selected from the group of metals consisting of Mg, Al, Y, Sc, Zr, Ti, V, Cr, Mo, Fe, Co, Cu, Ni, Zn and lanthanides.

6. The mixture according to claim 1, wherein the at least one bidentate organic compound is obtained from a dicarboxylic, tricarboxylic or tetracarboxylic acid.

7. The mixture according to claim 1, wherein the proportions of the components A and B in the mixture are 10-50% by weight of A and 50-90% by weight of B.

8. The mixture according to claim 1, wherein at least one of the components A and B is present as a shaped body.

9. The mixture according to claim 8, wherein component A is present as a star-shaped pellet.

10. The mixture according to claim 8, wherein component B is present in tablet form or as rod-shaped extrudate.

11. The mixture according to claim 8, wherein the shaped body has at least one dimension in the range from 0.2 mm to 5 cm in the case of component A and in the range from 0.2 to 30 mm in the case of component B.

12-13. (canceled)

14. A process for separating the substance from a mixture of substances, comprising
(a) contacting the substance with a mixture according to claim 1 and carrying out at least partial adsorption at a first pressure,
(b) carrying out at least partial release of the substance by desorption at a second pressure which is lower than the first pressure and
(c) optionally, repeating (a) and (b).

15. The process according to claim 14, wherein the repetition of the adsorption in (a) is carried out in a period of less than 60 minutes.

16. The process according to claim 14, wherein the first pressure is at least 1.2 bar (absolute).

17. The process according to claim 14, wherein the second pressure is not more than 1.1 bar (absolute).

18. The process according to claim 14, wherein the substance to be released comprises carbon dioxide.

19. The process according to claim 14, wherein the mixture of substances comprises at least one gas selected from the group consisting of methane, ethane, propane, n-butane, 2-methylbutane, carbon monoxide and hydrogen in addition to the substance to be released.
